(19) United States
(12) Patent Application Publication
(10) Pub. No.: US 2024/0317781 A1
(43) Pub. Date: Sep. 26, 2024

(54) MONO-SUBSTITUTED TIN COMPOUNDS AND RELATED METHODS

(71) Applicant: ENTEGRIS, INC., Billerica, MA (US)

(72) Inventors: David M. Ermert, Danbury, CT (US); Thomas M. Cameron, Newtown, CT (US); Claudia Fafard, New Milford, CT (US)

(21) Appl. No.: 18/612,002

(22) Filed: Mar. 21, 2024

Related U.S. Application Data
(60) Provisional application No. 63/453,611, filed on Mar. 21, 2023.

(51) Int. Cl. C07F 7/22

(52) U.S. Cl. CPC C07F 7/2208

(57) ABSTRACT

A method of synthesis of a mono-substituted tin compound comprises contacting a stannous halide with a metalated reactant to form a stannylene compound; contacting the stannylene compound with a halide compound to form a stannic compound; and contacting the stannic compound with a reactant to form a mono-substituted tin compound via ligand exchange. A composition comprising the mono-substituted tin compound is also provided, among other compositions and methods.

### CROSS-REFERENCE TO RELATED APPLICATIONS

This application claims the benefit under 35 USC 119 of U.S. Provisional Patent Application No. 63/453,611, filed Mar. 21, 2023, the disclosure of which is hereby incorporated herein by reference in its entirety.

### FIELD

The present disclosure relates to mono-substituted tin compounds and related methods.

### BACKGROUND

Some precursors are useful in the manufacture of microelectronic devices. The manufacture of such devices can involve use of extreme ultraviolet (EUV) lithography to form thin films.

### SUMMARY

Some embodiments relate to a method of synthesis. In some embodiments, the method of synthesis comprises any one or more of the following steps: contacting a stannous halide with a metalated reactant to form a stannylene compound; contacting the stannylene compound with a halide compound to form a stannic compound; and contacting the stannic compound with a reactant to form a mono-substituted tin compound via ligand exchange.

Some embodiments relate to a composition comprising a stannylene compound. In some embodiments, the stannylene compound is a reaction product of a stannous halide and a metalated reactant. In some embodiments, the stannylene compound comprises a compound of the formula:
where:
L is the monoanionic ligand or the dianionic ligand; and
n is 1 or 2, provided that n is 1 when L is the dianionic ligand and n is 2 when L is the monoanionic ligand.

Some embodiments relate to a composition comprising a stannic compound. In some embodiments, the stannic compound is a reaction product of a halide compound and a stannylene compound. In some embodiments, the stannic compound comprises a compound of the formula:

RSn(L)ₙX,
where:
R is or comprises at least one of an alkyl, an alkenyl, an alkynyl, a cycloalkyl, an aryl, a silyl, a silylalkyl, an aminoalkyl, an alkoxyalkyl, an arylalkyl, a fluoroalkyl, a haloalkyl, a silylated alkoxide, an ether, an amine, a halide, an imide, a cyanate, a nitrile, an alkoxide, or any combination thereof;
L is a monoanionic ligand or a dianionic ligand;
n is 1 or 2, provided that n is 1 when L is the dianionic ligand and n is 2 when L is the monoanionic ligand; and
X is a halide.

Some embodiments relate to a composition comprising a mono-substituted tin compound. In some embodiments, the mono-substituted tin compound comprises a compound of the formula:

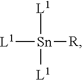

where:
R is or comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
L¹ is independently a monoanionic ligand, a dianionic ligand, or a halide.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method of synthesis, according to some embodiments.

FIG. 2 is a flowchart of a method for making a tin-containing film, according to some embodiments.

FIG. 3 depicts a reaction scheme of a method of forming a mono-substituted tin compound, according to some embodiments.

FIG. 4 depicts a reaction scheme of a method of forming a mono-substituted tin compound, according to some embodiments.

FIG. 5 depicts a schematic sectional view of a non-limiting embodiment of an ampoule, according to some embodiments.

FIG. 6 depicts a three-dimensional solid-state structure of Sn(pip^{Me4})₂, according to some embodiments.

FIG. 7 depicts a three-dimensional solid-state structure of CF₃CH₂Sn(N(SiMe₃)₂)₂I, according to some embodiments.

FIG. 8 depicts a three-dimensional solid-state structure of iPrSn(N(SiMe₃)₂)₂I, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may.

Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise.

In addition, throughout the specification, the meaning of “a,” “an,” and “the” include plural references. The meaning of “in” includes “in” and “on.”

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₉ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₀ alkenyl, C₁-C₁₄ alkenyl, C₁-C₁₃ alkenyl, C₁-C₁₂ alkenyl, C₁-C₁₁ alkenyl, C₁-C₁ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 1 to 30 carbon atoms and at least one carbon-carbon triple bond. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁ alkynyl, C₁-C₁₄ alkynyl, C₁-C₁₃ alkynyl, C₁-C₁₂ alkynyl, C₁-C₁₁ alkynyl, C₁-C₁ alkynyl, a C₁-C₉ alkynyl, a C₁-C₈ alkynyl, a C₁-C₇ alkynyl, a C₁-C₆ alkynyl, a C₁-C₈ alkynyl, a C₁-C₄ alkynyl, a C₁-C₃ alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₅-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

As used herein, the term “amino” refers to a functional group of formula —N(R^{a}R^{b}), wherein R^{a} and R^{b} are independently a hydrogen, an alkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, diisopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylaminos may include, without limitation, one or more of the following: primary alkylaminos, such as, for example and without limitation, methylamino, ethylamino, n-propylamino, isopropylamino, n-butylamino, sec-butylamino, isobutylamino, t-butylamino, pentylamino, 2-aminopentane, 3-aminopentane, 1-amino-2-methylbutane, 2-amino-2-methylbutane, 3-amino-2-methylbutane, 4-amino-2-methylbutane, hexylamino, 5-amino-2-methylpentane, heptylamino, octylamino, nonylamino, decylamino, undecylamino, dodecylamino, tridecylamino, tetradecylamino, pentadecylamino, hexadecylamino, heptadecylamino, and octadecylamino; and secondary alkylaminos, such as, for example and without limitation, dimethylamino, diethylamino, dipropylamino, diisopropylamino, dibutylamino, diisobutylamino, di-sec-butylamino, di-t-butylamino, dipentylamino, dihexylamino, diheptylamino, dioctylamino, dinonylamino, didecylamino, methylethylamino, methylpropylamino, methylisopropylamino, methylbutylamino, methylisobutylamino, methyl-sec-butylamino, methyl-t-butylamino, methylamylamino, methylisoamylamino, ethylpropylamino, ethylisopropylamino, ethylbutylamino, ethylisobutylamino, ethyl-sec-butylamino, ethylamino, ethylisoamylamino, propylbutylamino, and propylisobutylamino. Unless the context indicates otherwise, the term amino and amine may be used interchangeable herein.

As used herein, the term “alkoxy” refers to a functional group of formula —OR^{c}, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the term “silyl” refers to a functional group of formula —Si(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiR^{e}H₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula —Si(CH₃)₃.

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula -(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl)(aryl), wherein the alkyl is defined herein and the aryl is defined herein. In some embodiments, the aralkyl is —CH₂(C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{b}R^{c}R^{d}), wherein the alkyl is defined above and wherein R^{b}, R^{c}, and R^{d} are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

As used herein, the term “haloalkyl” refers to an alkyl as defined here, wherein at least one of the hydrogen atoms of the alkyl is replaced with a halide as defined herein. In some embodiments, the haloalkyl comprises a fluoroalkyl. In some embodiments, the fluoroalkyl comprises at least one of —CH₂CF₃, —CH(CF₃)₂, —CH₂F, —CH₂CH₂F, —CF₃, —CF₂CF₃, or any combination thereof.

As used herein, the term “halide” refers to a —Cl, —Br, —I, or —F.

As used herein, the term “metal cation” refers to at least one of a alkali metal cation, an alkaline earth metal cation, a transition metal cation, a post-transition metal cation, or any combination thereof. In some embodiments, the metal cation comprises a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallum cation, a lead cation, a bismuth cation, or a polonium cation. The charge(s) of the metal cations are known and, for simplicity, thus are not repeated here; however, it will be appreciated that the metal cations can have any known charge. For example, in some embodiments, the metal cation comprises Li⁺, Na⁺, K⁺, Rb⁺, Cs⁺, Mg²⁺, Ca²⁺, Sr²⁺, Ba²⁺, or Zn²⁺. In some embodiments, the metal cation is Sn(II) or Sn(IV).

Some embodiments relate to compositions useful in extreme-ultraviolet (EUV) lithography, among other applications, and related methods. The compositions disclosed herein include mono-substituted tin compounds. The mono-substituted tin compounds may be used to form tin-containing films useful in the fabrication of microelectronic devices, including semiconductor devices. For example, the precursor compositions may be used to form functionalized tin oxide films (RSnOx). The functionalized tin oxide films may be used in dry resist applications or as reflective coatings for extreme-ultraviolet (EUV) lithography, among others. The precursor compositions may be formed according to the methods disclosed herein in high yield and high purity (i.e., with low levels of disubstituted tin compounds, such as, for example and without limitation, dialkyl tin compounds, among others) while also minimizing the number of steps required to produce the precursor compositions.

As disclosed herein, it has unexpectedly been discovered that the ligands disclosed herein, such as, for example and without limitation, 2,2,6,6-tetramethylpiperidide, can promote formation of a monomeric Sn(II) stannylene when reacted with a stannous halide. It has further been unexpectedly discovered that the stannylene compounds disclosed herein readily undergo facile oxidative addition with halide compounds, such as, for example and without limitation, alkyl halides. It has further been unexpectedly discovered that the ligands disclosed herein can be readily exchanged with other ligands to provide wide-ranging versatility in the synthesis of mono-substituted tin compounds. It will be appreciated that other benefits of the compositions and methods disclosed herein exist and thus these shall not be limiting.

The tin-containing films may also be formed according to the methods disclosed herein. That is, the tin-containing films disclosed herein may be formed by one or more deposition processes that utilize the precursor compositions. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

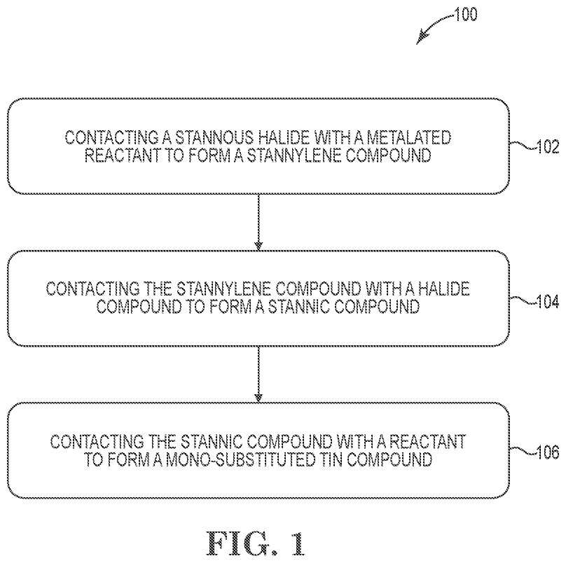

FIG. 1 is a flowchart of a method of synthesis, according to some embodiments. As shown in FIG. 1, the method of synthesis 100 comprises one or more of the following steps: contacting 102 a stannous halide with a metalated reactant to form a stannylene compound; contacting 104 the stannylene compound with a halide compound to form a stannic compound; and contacting 106 the stannic compound with a reactant to form a mono-substituted tin compound via ligand exchange.

At step 102, the method of synthesis 100 comprises contacting a stannous halide with a metalated reactant to form a stannylene compound. In some embodiments, the stannylene compound is formed via a substitution reaction in which the ligands from the metalated reactant replace the halides on the stannous halide. In some embodiments, the contacting comprises reacting the stannous halide with the metalated reactant. In some embodiments, the contacting comprises mixing the stannous halide and the metalated reactant. In some embodiments, the contacting comprises agitating the stannous halide and the metalated reactant. In some embodiments, the contacting comprises adding the stannous halide and the metalated reactant to a reaction vessel. In some embodiments, the contacting comprises dissolving the stannous halide and the metalated reactant. In some embodiments, the contacting comprises combining the stannous halide and the metalated reactant. In some embodiments, the contacting is performed in solution.

In some embodiments, the stannous halide comprises at least one of SnCl₂, SnBr₂, SnI₂, SnF₂, or any combination thereof.

In some embodiments, the metalated reactant comprises a compound of the formula:

ML,
where:
M is an alkali metal cation, an alkaline earth metal cation, a transition metal cation, or a post-transition metal cation; and
L is a monoanionic ligand or a dianionic ligand.

In some embodiments, the metal cation comprises an alkali metal cation and the ligand is a monoanionic ligand. In some embodiments, the metal cation comprises an alkali metal cation and the ligand is a dianionic ligand. In some embodiments, the metal cation comprises an alkali earth metal cation and the ligand is a monoanionic ligand. In some embodiments, the metal cation comprises an alkali earth metal cation and the ligand is a dianionic ligand. In some embodiments, the metal cation comprises a transition metal cation and the ligand is a monoanionic ligand. In some embodiments, the metal cation comprises a transition metal cation and the ligand is a dianionic ligand. In some embodiments, the metal cation comprises a post-transition metal cation and the ligand is a monoanionic ligand. In some embodiments, the metal cation comprises a post-transition metal cation and the ligand is a dianionic ligand.

In some embodiments, the monoanionic ligand is sufficiently bulky such that, when contacted with the stannous halide, the ligand promotes formation of a monomeric tin center. In some embodiments, the dianionic ligand is sufficiently bulky such that, when contacted with the stannous halide, the ligand promotes formation of a monomeric tin center.

In some embodiments, L is an amino. That is, for example, in some embodiments, L is:

—NR^{a}R^{b},
where:
R^{a} and R^{b} are independently a hydrogen, an alkyl, or a silyl, or R^{a} and R^{b} are bonded to each other to form a C₃-C₂₀ N-heterocycle.

In some embodiments, L is an alkoxy. That is, for example, in some embodiments, L is:

—OR^{c},
where:
R^{c} is an alkyl, a silylalkyl, a cycloalkyl, or an aryl.

In some embodiments, L is 2,2,6,6-tetramethylpiperidide. In some embodiments, L is N,N′-di-tert-butylethylenediamide. In some embodiments, L is bis(trimethylsilyl)amino. In some embodiments, L is —N(Si(CH₃)₃)₂.

In some embodiments, the metalated reactant comprises lithium tetramethylpiperidide.

In some embodiments, the stannylene compound is a reaction product of the stannous halide and the metalated reactant. In some embodiments, the stannylene compound comprises a compound of the formula:

SnLₙ,
where:
L is the monoanionic ligand or the dianionic ligand; and
n is 1 or 2, provided that n is 1 when L is the dianionic ligand. In some embodiments, n is 2 when L is the monoanionic ligand.

In some embodiments, L is the ligand from metalated reactant. For example, in some embodiments, L is an amino. That is, for example, in some embodiments, L is:

—NR^{a}R^{b},
where:
R^{a} and R^{b} are independently a hydrogen, an alkyl, or a silyl, or R^{a} and R^{b} are bonded to each other to form a C₃-C₂₀ N-heterocycle.

In some embodiments, L is an alkoxy. That is, for example, in some embodiments, L is:

—OR^{c},
where:
R^{c} is an alkyl, a silylalkyl, a cycloalkyl, or an aryl.

In some embodiments, L is 2,2,6,6-tetramethylpiperidide. In some embodiments, L is N,N′-di-tert-butylethylenediamide. In some embodiments, L is bis(trimethylsilyl)amino. In some embodiments, L is —N(Si(CH₃)₃)₂.

In some embodiments, the stannylene compound comprises tin (II) (2,2,6,6-tetramethylpiperidide)₂. In some embodiments, the stannylene compound is a compound of the formula:

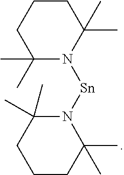

In some embodiments, the stannylene compound comprises tin (II) (N,N′-di-tert-butylethylenediamide)₂. In some embodiments, the stannylene compound comprises tin (II) ((trimethylsilyl)amino)₂.

At step 104, the method of synthesis 100 comprises contacting the stannylene compound with a halide compound to form a stannic compound. In some embodiments, the stannic compound is formed via oxidative addition in which the halide compound is oxidatively added to the stannylene compound (e.g., a low coordinate stannylene compound). In some embodiments, the contacting comprises reacting the stannylene compound with the halide compound. In some embodiments, the contacting comprises mixing the stannylene compound and the halide compound. In some embodiments, the contacting comprises agitating the stannylene compound and the halide compound. In some embodiments, the contacting comprises adding the stannylene compound and the halide compound to a reaction vessel. In some embodiments, the contacting comprises dissolving the stannylene compound and the halide compound. In some embodiments, the contacting comprises combining the stannylene compound and the halide compound. In some embodiments, the contacting is performed in solution.

In some embodiments, the halide compound comprises a compound of the formula:

RX,
where:
R is or comprises at least one of an alkyl, an alkenyl, an alkynyl, a cycloalkyl, an aryl, a silyl, a silylalkyl, an aminoalkyl, an alkoxyalkyl, an arylalkyl, a fluoroalkyl, a haloalkyl, a silylated alkoxide, an ether, an amine, a halide, an imide, a cyanate, a nitrile, an alkoxide, or any combination thereof; and
X is a halide.

In some embodiments, R is or comprises at least one of —CH₂CF₃, —CH(CF₃)₂, —CH₂F, —CH₂CH₂F, —CF₃, —CF₂CF₃, —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —C₆H₅, —CH₂(C₆H₅), —CH═CH₂, —C≡CCH₃, —CH₂C≡CH, —CH₂C≡CCH₃, —C(CH₃)═CH₂, —HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.

In some embodiments, the stannic compound is a reaction product of the stannous halide and the stannylene compound. In some embodiments, the stannic compound is an alkylated mixed ligand tin (IV) compound. In some embodiments, the stannic compound comprises a compound of the formula:

RSn(L)ₙX,
where:
R is or comprises at least one of an alkyl, an alkenyl, an alkynyl, a cycloalkyl, an aryl, a silyl, a silylalkyl, an aminoalkyl, an alkoxyalkyl, an arylalkyl, a fluoroalkyl, a haloalkyl, a silylated alkoxide, an ether, an amine, a halide, an imide, a cyanate, a nitrile, an alkoxide, or any combination thereof;
L is a monoanionic ligand or a dianionic ligand (as defined above);
n is 1 or 2, provided that n is 1 when L is the dianionic ligand. In some embodiments, n is 2 when L is the monoanionic ligand; and
X is a halide.

In some embodiments, R is the functional group from the halide compound. In some embodiments, R is or comprises at least one of —CH₂CF₃, —CH(CF₃)₂, —CH₂F, —CH₂CH₂F, —CF₃, —CF₂CF₃, —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —C₆H₅, —CH₂(C₆H₅), —CH═CH₂, —C≡CCH₃, —CH₂C≡CH, —CH₂C≡CCH₃, —C(CH₃)═CH₂, —HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.

In some embodiments, L is the ligand from the stannylene compound. In some embodiments, L is an amino. That is, for example, in some embodiments, L is:

—NR^{a}R^{b},
where:
R^{a} and R^{b} are independently a hydrogen, an alkyl, or a silyl, or R^{a} and R^{b} are bonded to each other to form a C₃-C₂₀ N-heterocycle.

In some embodiments, L is an alkoxy. That is, for example, in some embodiments, L is:

—OR^{c},
where:
R^{c} is an alkyl, a silylalkyl, a cycloalkyl, or an aryl.

In some embodiments, L is 2,2,6,6-tetramethylpiperidide. In some embodiments, L is N,N′-di-tert-butylethylenediamide. In some embodiments, L is bis(trimethylsilyl)amino.

In some embodiments, X is the halide from the halide compound.

In some embodiments, the stannic compound is a compound of the formula:

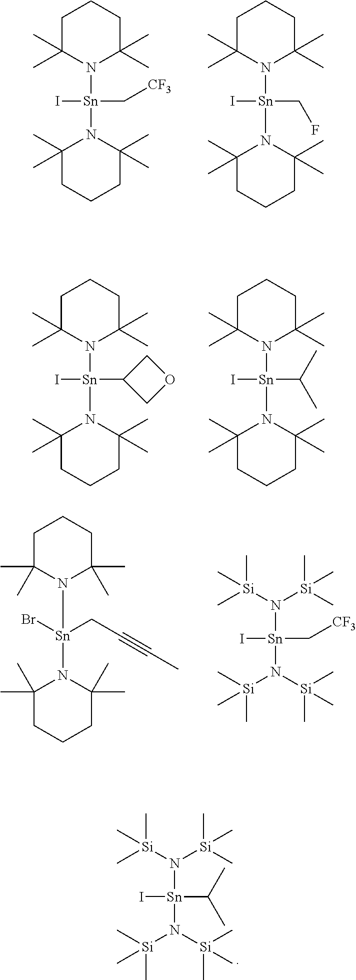

At step 106, the method of synthesis 100 comprises contacting the stannic compound with a reactant to form a mono-substituted tin compound. In some embodiments, the mono-substituted tin compound is formed via ligand exchange in which the ligand(s) and/or halide(s) from the reactant replace the ligand(s) and/or halide(s) on the stannic compound. In some embodiments, the contacting comprises reacting the stannic compound with the reactant. In some embodiments, the contacting comprises mixing the stannic compound and the reactant. In some embodiments, the contacting comprises agitating the stannic compound and the reactant. In some embodiments, the contacting comprises adding the stannic compound and the reactant to a reaction vessel. In some embodiments, the contacting comprises dissolving the stannic compound and the reactant. In some embodiments, the contacting comprises combining the stannic compound and the reactant. In some embodiments, the contacting is performed in solution.

In some embodiments, the reactant comprises at least one compound of the formula:

HL¹ or Mq¹L_{z}¹,
where:
L¹ is a monoanionic ligand, a dianionic ligand, or a halide;
M is an alkali metal cation, an alkaline earth metal cation, a transition metal cation, or a post-transition metal cation;
q is 1 or 2; and
z is 1, 2, 3, or 4.

In some embodiments, L¹ is —OR^{d}, —NR^{d}R^{e}, —NCO, —OC(═O)NR^{d}R^{e}, —NR^{d}C(═O)OR^{e}, —OC(═O)CH₃, —NR^{d}(CH₂)ₙNR^{d}R^{e}, —NR^{d}(CH₂)ₙR^{e}N—, —O(CH₂)ₙO—, —O(CH₂)ₙOR^{d}, —O(CH₂)ₙNR^{d}R^{e}, —O(CH₂)ₙR^{d}N—, or —C≡CR^{d}, where R^{d} and R^{e} are each independently a hydrogen, an alkyl, an alkenyl, an alkynyl, a cycloalkyl, an aryl, a silyl, a silylalkyl, an aminoalkyl, an alkoxyalkyl, or an aralkyl; and n is 1 to 30. In some embodiments, at least one of R^{d} or R^{e} is —Si(CH₃)₃. In some embodiments, each L¹ is independently:

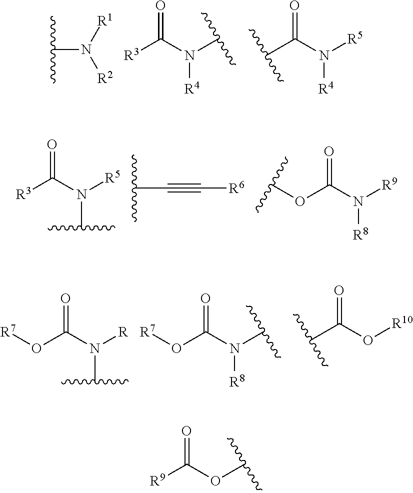

where:
R¹, R², R³, R⁴, R⁵, R⁶, R⁷, R⁸, R⁹, and R¹⁰ are independently an alkyl, an alkenyl, an alkynyl, a cycloalkyl, an aryl, a silyl, a silylalkyl, an aminoalkyl, an alkoxyalkyl, or an aralkyl.

In some embodiments, L¹ is —N(CH₃)₂. In some embodiments, L¹ is —OC(CH₃)₃. In some embodiments, L¹ is —C≡CC(CH₃)₃. In some embodiments, L¹ is —C≡CCH₃. In some embodiments, L¹ is —OSi(CH₃)₃. In some embodiments, L¹ is independently:

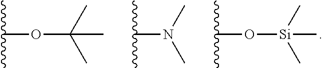

In some embodiments, the reactant comprises at least one of HC≡CCH₃, HOC(CH₃)₃, HC≡CC(CH₃)₃, HOSi(CH₃)₃, HNEt₂, NEts, 2,2,6,6-tetramethylpiperidine, Sn(N(CH₃)₂)₂, Sn(N(CH₃)₂)₄, Sn(OC(CH₃)₃)₂, Sn(OC(CH₃)₃)₄, SnCl₂, SnCl₄, SnI₂, SnI₄, SnBr₂, SnBr₄, LiN(CH₃)₂, Na(OC(CH₃)₃), K(OC(CH₃)₃), HOC(CH₃)₃, NaOSi(CH₃)₃, LiOSi(CH₃)₃, CH₃C≡CMgBr, NaCl, KCl, or any combination thereof. In some embodiments, the reactant comprises at least one of HC≡CCH₃, HOC(CH₃)₃, HC≡CC(CH₃)₃, HOSi(CH₃)₃, or any combination thereof. In some embodiments, the reactant further comprises at least one of HNEt₂, NEt₃, 2,2,6,6-tetramethylpiperidine, or any combination thereof. In some embodiments, the reactant comprises at least one of Sn(N(CH₃)₂)₂, Sn(N(CH₃)₂)₄, Sn(OC(CH₃)₃)₂, Sn(OC(CH₃)₃)₄, SnCl₂, SnCl₄, SnI₂, SnI₄, SnBr₂, SnBr₄, or any combination thereof. In some embodiments, the reactant comprises at least one of LiN(CH₃)₂, Na(OC(CH₃)₃), K(OC(CH₃)₃), HOC(CH₃)₃, NaOSi(CH₃)₃, LiOSi(CH₃)₃, CH₃C≡CMgBr, NaCl, KCl, or any combination thereof.

In some embodiments, the mono-substituted tin compound comprises a compound of the formula:

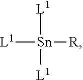

where:
R is or comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
L¹ is independently a monoanionic ligand, a dianionic ligand, or a halide.

In some embodiments, R is the functional group from the stannic compound. In some embodiments, R is or comprises at least one of —CH₂CF₃, —CH(CF₃)₂, —CH₂F, —CH₂CH₂F, —CF₃, —CF₂CF₃, —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —C₆H₅, —CH₂(C₆H₅), —CH═CH₂, —C≡CCH₃, —CH₂C≡CH, —CH₂C≡CCH₃, —C(CH₃)═CH₂, —HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.

In some embodiments, L¹ is from the reactant. In some embodiments, each L¹ is different. In some embodiments, each L¹ is the same. In some embodiments, at least two L¹ are the same. In some embodiments, at least two L¹ are different.

In some embodiments, L¹ is —OR^{d}, —NR^{d}R^{e}, —NCO, —OC(═O)NR^{d}R^{e}, —NR^{d}C(═O)OR^{e}, —OC(═O)CH₃, —NR^{d}(CH₂)ₙNR^{d}R^{e}, —NR^{d}(CH₂)ₙR^{e}N—, —O(CH₂)ₙO—, —O(CH₂)ₙOR^{d}, —O(CH₂)ₙNR^{d}R^{e}, —O(CH₂)ₙR^{d}N—, or —C≡CR^{d}, where R^{d} and R^{e} are each independently a hydrogen, an alkyl, an alkenyl, an alkynyl, a cycloalkyl, an aryl, a silyl, a silylalkyl, an aminoalkyl, an alkoxyalkyl, or an aralkyl; and n is 1 to 30. In some embodiments, at least one of R^{d} or R^{e} is —Si(CH₃)₃. In some embodiments, each L¹ is independently:

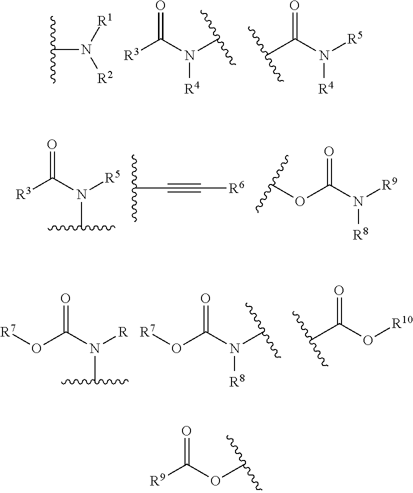

where:
R¹, R², R³, R⁴, R⁵, R⁶, R⁷, R⁸, R⁹, and R¹⁰ are independently an alkyl, an alkenyl, an alkynyl, a cycloalkyl, an aryl, a silyl, a silylalkyl, an aminoalkyl, an alkoxyalkyl, or an aralkyl.

In some embodiments, L¹ is —N(CH₃)₂. In some embodiments, L¹ is —OC(CH₃)₃. In some embodiments, L¹ is —C≡CC(CH₃)₃. In some embodiments, L¹ is —C≡CCH₃. In some embodiments, L¹ is —OSi(CH₃)₃. In some embodiments, L¹ is independently:

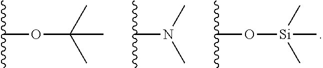

In some embodiments, the mono-substituted tin compound is a compound of the formula:

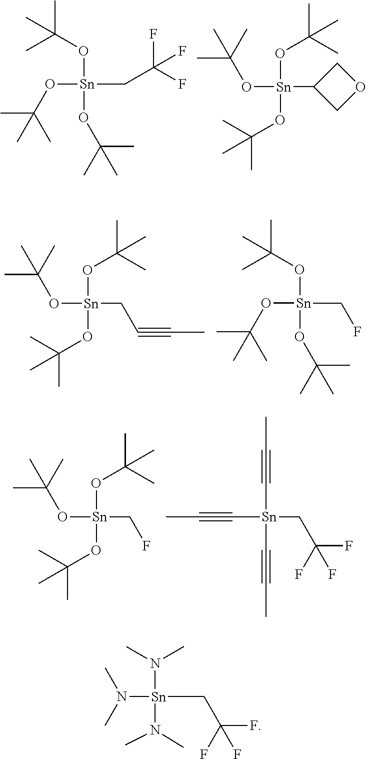

Some embodiments relate to a composition comprising a stannylene compound. In some embodiments, the stannylene compound is a reaction product of the stannous halide and the metalated reactant. In some embodiments, the stannylene compound comprises a compound of the formula:

SnLₙ,
where:
L is the monoanionic ligand or the dianionic ligand; and
n is 1 or 2, provided that n is 1 when L is the dianionic ligand. In some embodiments, n is 2 when L is the monoanionic ligand.

In some embodiments, L is the ligand from metalated reactant. For example, in some embodiments, L is an amino. That is, for example, in some embodiments, L is:

—NR^{a}R^{b},
where:
R^{a} and R^{b} are independently a hydrogen, an alkyl, or a silyl, or R^{a} and R^{b} are bonded to each other to form a C₃-C₂₀ N-heterocycle.

In some embodiments, L is an alkoxy. That is, for example, in some embodiments, L is:

—OR^{c},
where:
R^{c} is an alkyl, a silylalkyl, a cycloalkyl, or an aryl.

In some embodiments, L is 2,2,6,6-tetramethylpiperidide. In some embodiments, L is N,N′-di-tert-butylethylenediamide. In some embodiments, L is bis(trimethylsilyl)amino. In some embodiments, L is —N(Si(CH₃)₃)₂.

In some embodiments, the stannylene compound comprises tin (II) (2,2,6,6-tetramethylpiperidide)₂. In some embodiments, the stannylene compound is a compound of the formula:

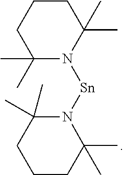

In some embodiments, the stannylene compound comprises tin (II) (N,N′-di-tert-butylethylenediamide)₂. In some embodiments, the stannylene compound comprises tin (II) ((trimethylsilyl)amino)₂.

Some embodiments relate to a composition comprising a stannic compound. In some embodiments, the stannic compound is a reaction product of the stannous halide and the stannylene compound. In some embodiments, the stannic compound is an alkylated mixed ligand tin (IV) compound. In some embodiments, the stannic compound comprises a compound of the formula:

RSn(L)ₙX,
where:
R is or comprises at least one of an alkyl, an alkenyl, an alkynyl, a cycloalkyl, an aryl, a silyl, a silylalkyl, an aminoalkyl, an alkoxyalkyl, an arylalkyl, a fluoroalkyl, a haloalkyl, a silylated alkoxide, an ether, an amine, a halide, an imide, a cyanate, a nitrile, an alkoxide, or any combination thereof;
L is a monoanionic ligand or a dianionic ligand (as defined above);
n is 1 or 2, provided that n is 1 when L is the dianionic ligand. In some embodiments, n is 2 when L is the monoanionic ligand; and
X is a halide.

In some embodiments, R is the functional group from the halide compound.

In some embodiments, R is or comprises at least one of —CH₂CF₃, —CH(CF₃)₂, —CH₂F, —CH₂CH₂F, —CF₃, —CF₂CF₃, —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —C₆H₅, —CH₂(C₆H₅), —CH═CH₂, —C≡CCH₃, —CH₂C≡CH, —CH₂C≡CCH₃, —C(CH₃)═CH₂, —HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.

In some embodiments, L is the ligand from the stannylene compound. In some embodiments, L is an amino. That is, for example, in some embodiments, L is:

—NR^{a}R^{b},
where:
R^{a} and R^{b} are independently a hydrogen, an alkyl, or a silyl, or R^{a} and R^{b} are bonded to each other to form a C₃-C₂₀ N-heterocycle.

In some embodiments, L is an alkoxy. That is, for example, in some embodiments, L is:

—OR^{c},
where:
R^{c} is an alkyl, a silylalkyl, a cycloalkyl, or an aryl.

In some embodiments, L is 2,2,6,6-tetramethylpiperidide. In some embodiments, L is N,N′-di-tert-butylethylenediamide. In some embodiments, L is bis(trimethylsilyl)amino.

In some embodiments, X is the halide from the halide compound.

In some embodiments, the stannic compound is a compound of the formula:

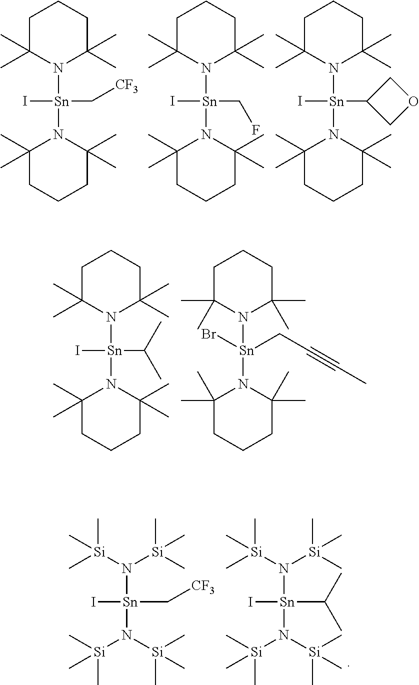

Some embodiments relate to a composition comprising a mono-substituted tin compound. In some embodiments, the mono-substituted tin compound comprises a compound of the formula:

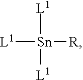

where:
R is or comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
L¹ is independently a monoanionic ligand, a dianionic ligand, or a halide.

In some embodiments, R is or comprises at least one of the functional group from the stannic compound. In some embodiments, R is —CH₂CF₃, —CH(CF₃)₂, —CH₂F, —CH₂CH₂F, —CF₃, —CF₂CF₃, —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —C₆H₅, —CH₂(C₆H₅), —CH═CH₂, —C≡CCH₃, —CH₂C≡CH, —CH₂C≡CCH₃, —C(CH₃)═CH₂, —HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.

In some embodiments, L¹ is from the reactant. In some embodiments, each L¹ is different. In some embodiments, each L¹ is the same. In some embodiments, at least two L¹ are the same. In some embodiments, at least two L¹ are different. In some embodiments, L¹ is —OR^{d}, —NR^{d}R^{e}, —NCO, —OC(═O)NR^{d}R^{e}, —NR^{d}C(═O)OR^{e}, —OC(═O)CH₃, —NR^{d}(CH₂)ₙNR^{d}R^{e}, —NR^{d}(CH₂)ₙR^{e}N—, —O(CH₂)ₙO—, —O(CH₂)ₙOR^{d}, —O(CH₂)ₙNR^{d}R^{e}, —O(CH₂)ₙR^{d}N—, or —C≡CR^{d}, where R^{d} and R^{e} are each independently a hydrogen, an alkyl, an alkenyl, an alkynyl, a cycloalkyl, an aryl, a silyl, a silylalkyl, an aminoalkyl, an alkoxyalkyl, or an aralkyl; and n is 1 to 30. In some embodiments, at least one of R^{d} or R^{e} is —Si(CH₃)₃. In some embodiments, each L¹ is independently:

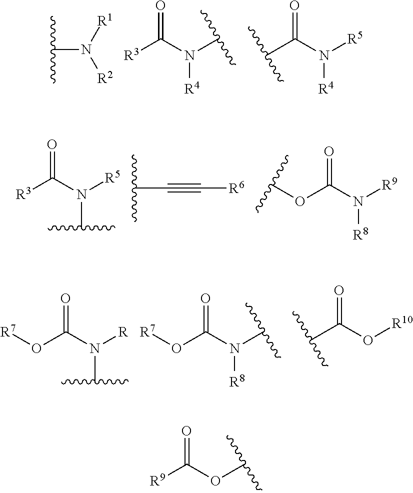

where:
R¹, R², R³, R⁴, R⁵, R⁶, R⁷, R⁸, R⁹, and R¹⁰ are independently an alkyl, an alkenyl, an alkynyl, a cycloalkyl, an aryl, a silyl, a silylalkyl, an aminoalkyl, an alkoxyalkyl, or an aralkyl.

In some embodiments, L¹ is —N(CH₃)₂. In some embodiments, L¹ is —OC(CH₃)₃. In some embodiments, L¹ is —C≡CC(CH₃)₃. In some embodiments, L¹ is —C≡CCH₃. In some embodiments, L¹ is —OSi(CH₃)₃. In some embodiments, L¹ is independently:

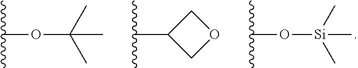

In some embodiments, the mono-substituted tin compound is a compound of the formula:

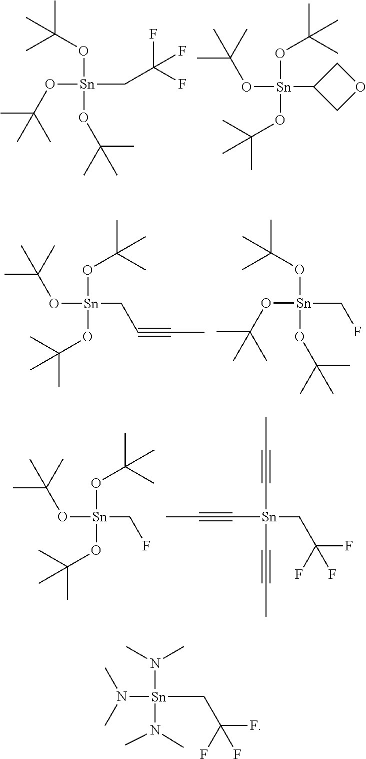

In some embodiments, a disubstituted tin (IV) compound, such as, for example and without limitation, a dialkyl tin (IV) compound, when present, have a negative effect on crosslinking during EUV exposure. Accordingly, in some embodiments, high purity compositions, with low levels of disubstituted tin (IV) compounds, is desired. At least one advantage of the method of synthesis is that mono-substituted tin compounds are formed with high purity and, in some instances, undetectable levels of disubstituted tin (IV) compounds.

In some embodiments, the composition comprises less than 5% by weight of a disubstituted tin (IV) compound based on a total weight of the composition. For example, in some embodiments, the composition comprises less than 4.5%, less than 4%, less than 3.5%, less than 3%, less than 2.5%, less than 2%, less than 1.5%, less than 1%, less than 0.5%, less than 0.1%, less than 0.01%, less than 0.001%, or less than 0.0001% by weight of a disubstituted tin (IV) compound based on a total weight of the composition. In some embodiments, the composition comprises at least 95%, at least 95.5%, at least 96%, at least 96.5%, at least 97%, at least 97.5%, at least 98%, at least 98.5%, at least 99%, at least 99.5%, at least 99.9%, at least 99.99%, at least 99.999%, at least 99.9999% by weight of the mono-substituted tin compound based on a total weight of the composition. In some embodiments, the composition comprises 95% to 99.9999%, 95.5% to 99.9999%, 96% to 99.9999%, 96.5% to 99.9999%, 97% to 99.9999%, 97.5% to 99.9999%, 98% to 99.9999%, 98.5% to 99.9999%, 99% to 99.9999%, 99.5% to 99.9999%, 99.9% to 99.9999%, 99.99% to 99.9999%, 99.999% to 99.9999%, 95% to 99.999%, 95% to 999%, 95% to 99%, 95% to 99.5%, 95% to 99%, 95% to 98.5%, 95% to 98%, 95% to 97.5%, 95% to 97%, 95% to 96.5%, 95% to 96%, or 95% to 95.5%.

In some embodiments, the disubstituted tin (IV) compound is a compound of the formula:

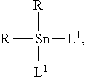

where:
R is or comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
L¹ is independently a monoanionic ligand, a dianionic ligand, or a halide.

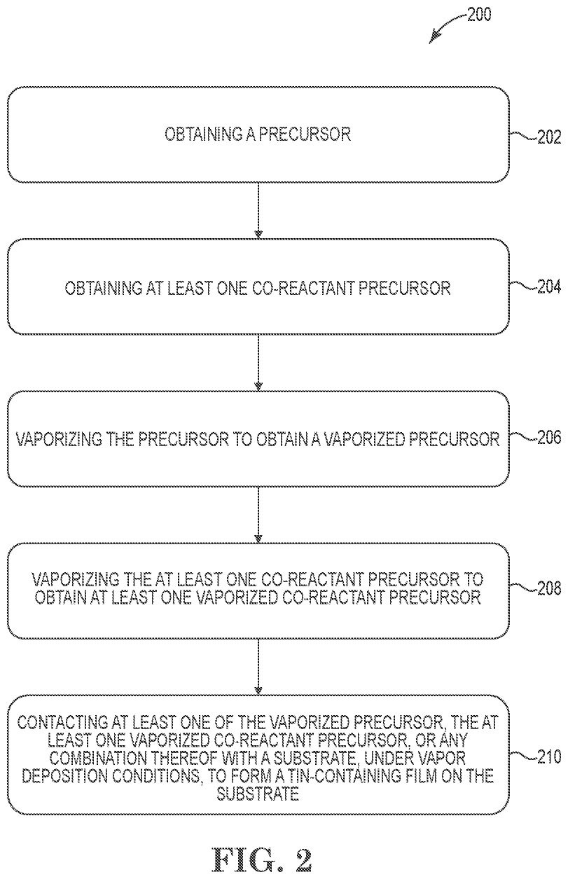

FIG. 2 is a flowchart of a method for making a tin-containing film 200, according to some embodiments. As shown in FIG. 2, the method for making a tin-containing film 200 may comprise, consist of, or consist essentially of one or more of the following steps: obtaining 202 a precursor, obtaining 204 at least one co-reactant precursor, vaporizing 206 the precursor to obtain a vaporized precursor, vaporizing 208 the at least one co-reactant precursor to obtain at least one vaporized co-reactant precursor, contacting 210 at least one of the vaporized precursor, the at least one vaporized co-reactant precursor, or any combination thereof with a substrate, under vapor deposition conditions, to form a tin-containing film on the substrate.

The step 202 may comprise, consist of, or consist essentially of obtaining a precursor. The precursor may comprise, consist of, or consist essentially of any one or more of the compositions comprising mono-substituted tin compounds disclosed herein. The obtaining may comprise obtaining a container or other vessel comprising the precursor. In some embodiments, the precursor may be obtained in a container or other vessel in which the precursor is to be vaporized.

The step 204 may comprise, consist of, or consist essentially of obtaining at least one co-reactant precursor. In some embodiments, the at least one co-reactant precursor comprises, consists of, or consists essentially of, or is selected from the group consisting of, at least one of an oxidizing gas, a reducing gas, a hydrocarbon, or any combination thereof. The at least one co-reactant precursor may be selected to obtain a desired tin-containing film. In some embodiments, the at least one co-reactant precursor may comprise, consist of, or consist essentially of at least one of N₂, H₂, NH₃, N₂H₄, CH₃HNNH₂, CH₃HNNHCH₃, NCH₃H₂, NCH₃CH₂H₂, N(CH₃)₂H, N(CH₃CH₂)₂H, N(CH₃)₃, N(CH₃CH₂)₃, Si(CH₃)₂NH, pyrazoline, pyridine, ethylene diamine, or any combination thereof. In some embodiments, the at least one co-reactant precursor may comprise, consist of, or consist essentially of at least one of H₂, O₂, O₃, H₂O, H₂O₂, NO, N₂O, NO₂, CO, CO₂, a carboxylic acid, an alcohol, a diol, or any combination thereof. In some embodiments, the at least one co-reactant precursor comprise, consist of, or consist essentially of at least one of methane, ethane, ethylene, acetylene, or any combination thereof. The obtaining may comprise obtaining a container or other vessel comprising the at least one co-reactant precursor. In some embodiments, the at least one co-reactant precursor may be obtained in a container or other vessel in which the at least one co-reactant precursor is to be vaporized. In some embodiments, the method further comprises an inert gas, such as, for example, at least one of argon, helium, nitrogen, or any combination thereof.

The step 206 may comprise, consist of, or consist essentially of vaporizing the precursor to obtain a vaporized precursor. The vaporizing may comprise, consist of, or consist essentially of heating the precursor sufficient to obtain the vaporized precursor. In some embodiments, the vaporizing may comprise, consist of, or consist essentially of heating a container comprising the precursor. In some embodiments, the vaporizing may comprise, consist of, or consist essentially of heating the precursor in a deposition chamber in which the vapor deposition process is performed. In some embodiments, the vaporizing may comprise, consist of, or consist essentially of heating a conduit for delivering the precursor, vaporized precursor, or any combination thereof to, for example, a deposition chamber. In some embodiments, the vaporizing may comprise, consist of, or consist essentially of operating a vapor delivery system comprising the precursor. In some embodiments, the vaporizing may comprise, consist of, or consist essentially of heating to a temperature sufficient to vaporize the precursor to obtain the vaporized precursor. In some embodiments, the vaporizing may comprise, consist of, or consist essentially of heating to a temperature below a decomposition temperature of at least one of the precursor, the vaporized precursor, or any combination thereof. In some embodiments, the precursor may be present in a gas phase, in which case the step 206 is optional and not required. For example, the precursor may comprise, consist of, or consist essentially of the vaporized precursor.

The step 208 may comprise, consist of, or consist essentially of vaporizing the at least one co-reactant precursor to obtain the at least one vaporized co-reactant precursor. In some embodiments, the vaporizing may comprise, consist of, or consist essentially of heating the at least one co-reactant precursor sufficient to obtain the at least one vaporized co-reactant precursor. In some embodiments, the vaporizing may comprise, consist of, or consist essentially of heating a container comprising the at least one co-reactant precursor. In some embodiments, the vaporizing may comprise, consist of, or consist essentially of heating the at least one co-reactant precursor in a deposition chamber in which the vapor deposition process is performed. In some embodiments, the vaporizing may comprise, consist of, or consist essentially of heating a conduit for delivering the at least one co-reactant precursor, the at least one vaporized co-reactant precursor, or any combination thereof to, for example, a deposition chamber. In some embodiments, the vaporizing may comprise, consist of, or consist essentially of operating a vapor delivery system comprising the at least one co-reactant precursor. In some embodiments, the vaporizing may comprise, consist of, or consist essentially of heating to a temperature sufficient to vaporize the at least one co-reactant precursor to obtain the at least one vaporized co-reactant precursor. In some embodiments, the vaporizing may comprise, consist of, or consist essentially of heating to a temperature below a decomposition temperature of at least one of the at least one co-reactant precursor, the at least one vaporized co-reactant precursor, or any combination thereof. In some embodiments, the at least one co-reactant precursor may be present in a gas phase, in which case the step 108 is optional and not required. For example, the at least one co-reactant precursor may comprise, consist of, or consist essentially of the at least one vaporized co-reactant precursor.

The step 210 may comprise, consist of, or consist essentially of contacting at least one of the vaporized precursor, the at least one vaporized co-reactant precursor, or any combination thereof, with the substrate, under vapor deposition conditions, sufficient to form a tin-containing film on a surface of the substrate. The contacting may be performed in any system, apparatus, device, assembly, chamber thereof, or component thereof suitable for vapor deposition processes, including, for example and without limitation, a deposition chamber, among others. The vaporized precursor and the at least one co-reactant precursor may be contacted with the substrate at the same time or at different times. For example, each of the vaporized precursor, the at least one vaporized co-reactant precursor, and the substrate may be present in the deposition chamber at the same time. That is, in some embodiments, the contacting may comprise contemporaneous contacting or simultaneous contacting of the vaporized precursor and the at least one vaporized co-reactant precursor with the substrate. Alternatively, each of the vaporized precursor and the at least one vaporized co-reactant precursor may be present in the deposition chamber at different times. That is, in some embodiments, the contacting may comprise alternate and/or sequential contacting, in one or more cycles, of the vaporized precursor with the substrate and subsequently contacting the at least one vaporized co-reactant precursor with the substrate.

The vapor deposition conditions may comprise conditions for vapor deposition processes. Examples of vapor deposition conditions include, without limitation, vapor deposition conditions for vapor deposition processes including at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

The vapor deposition conditions may comprise, consist of, or consist essentially of a deposition temperature. The deposition temperature may be a temperature less than the thermal decomposition temperature of at least one of the vaporized precursor, the at least one vaporized co-reactant precursor, or any combination thereof. The deposition temperature may be sufficiently high to reduce or avoid condensation of at least one of the vaporized precursor, the at least one vaporized co-reactant precursor, or any combination thereof. In some embodiments, the substrate may be heated to the deposition temperature. In some embodiments, the chamber or other vessel in which the substrate is contacted with the vaporized precursor and the at least one vaporized co-reactant precursor is heated to the deposition temperature. In some embodiments, at least one of the vaporized precursor, the at least one vaporized co-reactant precursor, or any combination thereof may be heated to the deposition temperature.

The deposition temperature may be a temperature of 200° C. to 2500° C. In some embodiments, the deposition temperature may be a temperature of 500° C. to 700° C. For example, in some embodiments, the deposition temperature may be a temperature of 500° C. to 680° C., 500° C. to 660° C., 500° C. to 640° C., 500° C. to 620° C., 500° C. to 600° C., 500° C. to 580° C., 500° C. to 560° C., 500° C. to 540° C., 500° C. to 520° C., 520° C. to 700° C., 540° C. to 700° C., 560° C. to 700° C., 580° C. to 700° C., 600° C. to 700° C., 620° C. to 700° C., 640° C. to 700° C., 660° C. to 700° C., or 680° C. to 700° C. In other embodiments, the deposition temperature may be a temperature of greater than 200° C. to 2500° C., such as, for example and without limitation, a temperature of 400° C. to 2000, 500° C. to 2000° C., 550° C. to 2400° C., 600° C. to 2400° C., 625° C. to 2400° C., 650° C. to 2400° C., 675° C. to 2400° C., 700° C. to 2400° C., 725° C. to 2400° C., 750° C. to 2400° C., 775° C. to 2400° C., 800° C. to 2400° C., 825° C. to 2400° C., 850° C. to 2400° C., 875° C. to 2400° C., 900° C. to 2400° C., 925° C. to 2400° C., 950° C. to 2400° C., 975° C. to 2400° C., 1000° C. to 2400° C., 1025° C. to 2400° C., 1050° C. to 2400° C., 1075° C. to 2400° C., 1100° C. to 2400° C., 1200° C. to 2400° C., 1300° C. to 2400° C., 1400° C. to 2400° C., 1500° C. to 2400° C., 1600° C. to 2400° C., 1700° C. to 2400° C., 1800° C. to 2400° C., 1900° C. to 2400° C., 2000° C. to 2400° C., 2100° C. to 2400° C., 2200° C. to 2400° C., 2300° C. to 2400° C., 500° C. to 2000° C., 500° C. to 1900° C., 500° C. to 1800° C., 500° C. to 1700° C., 500° C. to 1600° C., 500° C. to 1500° C., 500° C. to 1400° C., 500° C. to 1300° C., 500° C. to 1200° C., 500° C. to 1100° C., 500° C. to 1000° C., 500° C. to 1000° C., 500° C. to 900° C., or 500° C. to 800° C.

The vapor deposition conditions may comprise, consist of, or consist essentially of a deposition pressure. In some embodiments, the deposition pressure may comprise, consist of, or consist essentially of a vapor pressure of at least one of the vaporized precursor, the at least one vaporized co-reactant precursor, or any combination thereof. In some embodiments, the deposition pressure may comprise, consist of, or consist essentially of a chamber pressure.

The deposition pressure may be a pressure of 0.001 Torr to 100 Torr. For example, in some embodiments, the deposition pressure may be a pressure of 1 Torr to 30 Torr, 1 Torr to 25 Torr, 1 Torr to 20 Torr, 1 Torr to 15 Torr, 1 Torr to 10 Torr, 5 Torr to 50 Torr, 5 Torr to 40 Torr, 5 Torr to 30 Torr, 5 Torr to 20 Torr, or 5 Torr to 15 Torr. In other embodiments, the deposition pressure may be a pressure of 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, 95 Torr to 100 Torr, 1 Torr to 95 Torr, 1 Torr to 90 Torr, 1 Torr to 85 Torr, 1 Torr to 80 Torr, 1 Torr to 75 Torr, or 1 Torr to 70 Torr. In other further embodiments, the deposition pressure may be a pressure of 1 mTorr to 100 mTorr, 1 mTorr to 90 mTorr, 1 mTorr to 80 mTorr, 1 mTorr to 70 mTorr, 1 mTorr to 60 mTorr, 1 mTorr to 50 mTorr, 1 mTorr to 40 mTorr, 1 mTorr to 30 mTorr, 1 mTorr to 20 mTorr, 1 mTorr to 10 mTorr, 100 mTorr to 300 mTorr, 150 mTorr to 300 mTorr, 200 mTorr to 300 mTorr, or 150 mTorr to 250 mTorr, or 150 mTorr to 225 mTorr.

The substrate may comprise, consist of, or consist essentially of at least one of Si, Co, Cu, Al, W, WN, WC, TiN, Mo, MoC, SiO₂, W, SiN, WCN, Al₂O₃, AlN, ZrO₂, La₂O₃, TaN, RuO₂, IrO₂, Nb₂O₃, Y₂O₃, hafnium oxide, or any combination thereof.

The tin-containing film may comprise a tin oxide or a tin oxide film. In some embodiments, the tin-containing film comprises a functionalized tin oxide. In some embodiments, the tin-containing film comprises a functionalized tin oxide of the formula: RSnO_{z}, where z is 1 to 6. In some embodiments, R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, an ether, an amine, a halide, an imide, a cyanate, a nitrile, or an alkoxide.

Some embodiments relate to a tin-containing film on a surface of a substrate. In some embodiments, the tin-containing film comprises any film formed according to the methods disclosed herein. In some embodiments, the tin-containing film comprises any film prepared from the precursors disclosed herein.

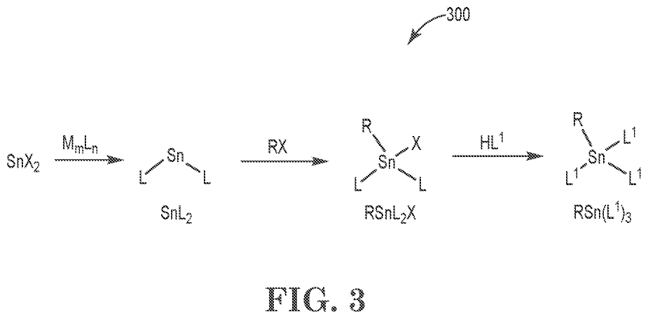

FIG. 3 depicts a reaction scheme of a method 300 of forming a mono-substituted tin compound, according to some embodiments. As shown in FIG. 3, the method 300 of forming the mono-substituted tin compound comprises reacting a stannous halide and a metalated reactant to form a stannylene compound via substitution. The stannylene compound comprises monoanionic ligands on tin (II). A halide compound is reacted with the stannylene compound to form a stannic compound via oxidative addition. The stannic compound is reacted with a reactant to form the mono-substituted tin compound via ligand exchange.

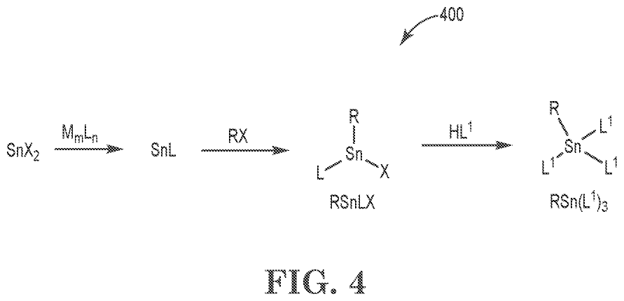

FIG. 4 depicts a reaction scheme of a method 400 of forming a mono-substituted tin compound, according to some embodiments. As shown in FIG. 4, the method 400 of forming the mono-substituted tin compound comprises reacting a stannous halide and a metalated reactant to form a stannylene compound via substitution. The stannylene compound comprises a dianionic ligand on tin (II). A halide compound is reacted with the stannylene compound to form a stannic compound via oxidative addition. The stannic compound is reacted with a reactant to form the mono-substituted tin compound via ligand exchange.

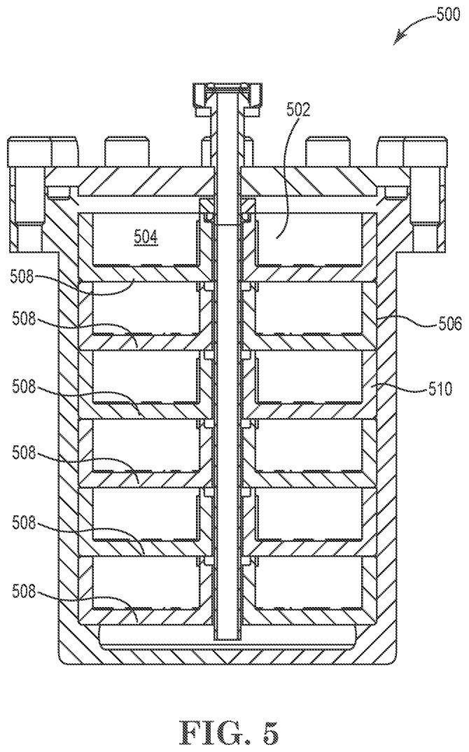

FIG. 5 depicts a schematic sectional view of a non-limiting embodiment of an ampoule 500, according to some embodiments. The ampoule 500 contains a tray assembly 502 in an inner chamber 504 of the ampoule 500. The inner chamber 504 has an inner wall surface 506. The tray assembly 502 comprises trays 508, each of which are configured to contain a vaporizable precursor. In some embodiments, the vaporizable precursor comprises any one or more of the compositions disclosed herein, including compositions comprising the mono-substituted tin compounds. Each of the trays 508 of the tray assembly 502 comprises a portion 510 which is configured to be in contact (e.g., thermal contact, physical contact, etc.) with the inner wall surface 506 of the ampoule 500. The surface-to-surface contact of the portion 510 with the inner wall surface 506 enhances heat transfer from the ampoule 500 to each tray 508 and thus from each tray 508 to the vaporizable precursor on each tray 508. Various fluid flow paths are defined within the inner chamber 504 of the ampoule 500 such that a fluid is allowed to flow through the ampoule 500 upwards, downwards, or both. The ampoule 500 is shown having a generally cylindrical inner chamber. However, it will be appreciated that the inner chamber 504 of the ampoule may have other shapes without departing from the scope of this disclosure.

### Example 1

### Synthesis of Sn(pip^{Me4})₂

2,2,6,6-tetramethylpiperidine (Hpip^{Me4}) (29.3 g, 208 mmol) was transferred to a 500 mL Schlenk flask equipped with a magnetic stir bar and diluted with 200 mL of hexanes. nBuLi (1.6M in hexanes, 130.0 mL, 209 mmol) was added to the amine solution over the course of 30 minutes, resulting in a slight exotherm and the appearance of a white mixture. After stirring the reaction for 2 hours, 100 mL of THE was added to form a slightly hazy amber solution. Separately, a THE (100 mL) solution of SnCl₂ (20.0 g, 104 mmol) was prepared in a 1 L Schlenk flask equipped with a magnetic stir bar. The Lipip^{Me4} solution was added to the SnCl₂ solution via addition funnel over the course of 1 hour, whereby, upon addition the reaction immediately began to present as a blood-red solution. Upon complete addition the resulting dark red mixture was stirred at room temperature overnight.

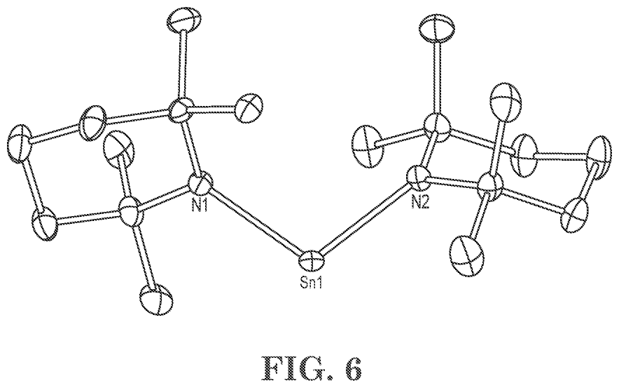

The following morning the volatiles were removed from the reaction mixture under reduced pressure, the product extracted with 200 mL hexanes, filtered through a disposable polyethylene filter frit, and the resulting dark red solution dried under reduced pressure to yield a red solid product. Mass: 24.1 g, 57.7% yield. M.P.: 73.3° C. (DSC). X-ray quality crystals were grown from cooling a saturated PhMe solution at −35° C. ¹H-NMR (400 MHz, C₆D₆, 298K): 1.39 (t, 8H); 1.50 (s, 24H); 1.71 (m, 4H) ppm; ¹³C{¹H}-NMR (100 MHz, C₆D₆, 298K): 19.07; 34.50; 43.15; 57.90 ppm; ¹¹⁹Sn{¹H}-NMR (149 MHz, C₆D₆, 298K): 752.5 ppm. FIG. 6 depicts a three-dimensional solid-state structure of Sn(pip^{Me4})₂, according to some embodiments.

### Example 2

### Synthesis of CF₃CH₂Sn(pip^{Me4})₂I

Sn(pip^{Me4})₂ (5.0 g, 12.4 mmol) was placed in a 40 mL amber vial equipped with a magnetic stir bar and dissolved in 30 mL of hexanes to form a dark red solution. ICH₂CF₃ (2.72 g, 13.0 mmol) was diluted with 5 mL of hexanes and added to the Sn-amide solution via pipette over the course of two minutes. The resulting dark red solution stirred overnight. The following morning the volatiles were removed from the dark red solution under reduced pressure to yield the product as a thick red/brown viscous liquid. Mass: 7.22 g, yield 95.6%. ¹H-NMR (400 MHz, C₆D₆, 298K): 1.37 (m, 8H); 1.48 (s, 12H); 1.50 (s, 12H); 1.53 (m, 4H); 2.55 (q, 2H) ppm; ¹³C{¹H}-NMR (100 MHz, C₆D₆, 298K): 17.28; 33.92; 34.42; 41.33; 42.84 (q); 59.20; 128.52 (q) ppm; ¹¹⁹Sn{¹H}-NMR (149 MHz, C₆D₆, 298K): −342.42 (q) ppm. ¹⁹F-NMR (376 MHz, C₆D₆, 298K): −49.54 (t) ppm.

### Example 3

### Synthesis of FCH₂Sn(pip^{Me4})₂I

Sn(pip^{Me4})₂ (2.5 g, 6.23 mmol) was placed in a 40 mL amber vial equipped with a magnetic stir bar and dissolved in 20 mL of tetrahydrofuran to form a dark red solution which was cooled to −35° C. ICH₂F (1.04 g, 6.54 mmol) was diluted with 5 mL of THF and added to the Sn-amide solution via pipette over the course of two minutes. The resulting dark red solution stirred overnight. The following morning the volatiles were removed from the dark red solution under reduced pressure to yield the product as a thick red/brown viscous liquid. Mass: 2.99 g, yield 85.9%. ¹H-NMR (400 MHz, C₆D₆, 298K): 1.25-1.55 (bm, 36H); 4.75 (d, 2H) ppm; ¹¹⁹Sn{¹H}-NMR (149 MHz, C₆D₆, 298K): −258.32 (d) ppm. ¹⁹F-NMR (376 MHz, C₆D₆, 298K): −226.24 (t) ppm.

### Example 4

### Synthesis of O(CH₂)₂HCSn(pip^{Me4})₂I

In a nitrogen-filled glovebox, Sn(pip^{Me4})₂ (2.0 g, 4.98 mmol) was loaded into an amber 40 mL vial equipped with a magnetic stir bar, dissolved in 10 mL of THF and cooled to −35° C. A 5 mL THF solution of 1-iodooxetane (0.96 g, 5.22 mmol) was added dropwise with stirring to the cooled Sn-amide solution over the course of two minutes, at which point the reaction was stirred at room temperature for 12 hours. The resulting dark reddish/brown solution was dried under reduced pressure to yield a tacky highly viscous dark red/brown oil. ¹H-NMR (400 MHz, C₆D₆, 298K): 1.1-1.5 (bm, 36H); 3.16 (pent, 1H); 4.63 (t, 2H); 5.02 (t, 2H) ppm; ¹¹⁹5n{¹H}-NMR (149 MHz, C₆D₆, 298K): −190.88 ppm.

### Example 5

### Synthesis of CF₃CH₂Sn(C≡CCH₃)₃

Synthesis of CF₃CH₂Sn(pip^{Me4})₂I (0.500 g, 0.769 mmol) was placed in a 40 mL amber vial equipped with a magnetic stir bar and dissolved in 5 mL of THE. Propyne (1M in THF, 4.61 mL, 4.61 mmol) was added directly to the CF₃CH₂Sn(pip^{Me4})₂I solution and the resulting light orange solution stirred overnight at room temperature. The following morning the reaction presented as a tangerine-colored mixture, the volatiles were removed under reduced pressure, the product extracted with 2 mL of C₆D₆ and filtered through a 0.2 μm syringe filter to yield an orange solution of the product. ¹H-NMR (400 MHz, C₆D₆, 298K): 1.40 (s, 9H); 1.60 (q, 2H) ppm; ¹³C{¹H}-NMR (100 MHz, C₆D₆, 298K): 4.47; 21.11 (q); 75.07; 108.96; 128.39 (q) ppm; ¹¹⁹Sn{¹H}-NMR (149 MHz, C₆D₆, 298K): −275.37 (q) ppm. ¹⁹F-NMR (376 MHz, C₆D₆, 298K): −52.74 (t) ppm.

### Example 6

### Synthesis of CF₃CH₂Sn(N(SiMe₃)₂)₂I

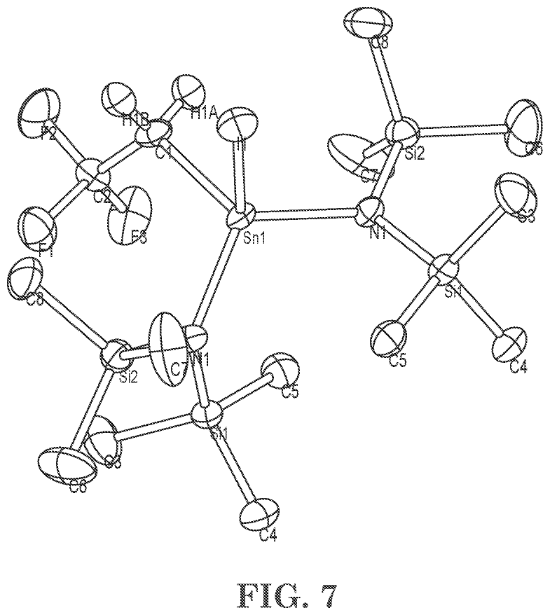

Sn(N(SiMe₃)₂)₂ (25.0 g, 56.5 mmol) was loaded into a 250 mL roundbottom flask equipped with a magnetic stir bar and dissolved in hexanes (100 mL) to form a dark orange/red solution. ICH₂CF₃ was massed in a separate vial (11.8 g, 56.6 mmol) and then added to the hexanes solution over the course of ten minutes, during which time a slight exotherm and lightening of the solution color was observed. The resulting light orange solution was stirred at room temperature for 20 mins, at which point the solvent was removed under reduced pressure to yield a free-flowing light-yellow solid. Mass: 34.34 g, 93.4% yield. X-ray quality crystals were grown by cooling a saturated hexanes solution at −35° C. ¹H-NMR (400 MHz, C₆D₆, 298K): 0.32 (s, 36H); 2.42 (q, 2H) ppm; ¹³C{¹H}-NMR (100 MHz, C₆D₆, 298K): 5.98; 34.86 (q); 127.72 (q) ppm; ¹⁹F-NMR (376 MHz, C₆D₆, 298K): −50.2 (t) ppm; ¹¹⁹Sn{¹H}-NMR (149 MHz, C₆D₆, 298K): −249.82 (q) ppm. FIG. 7 depicts a three-dimensional solid-state structure of CF₃CH₂Sn(N(SiMe₃)₂)₂I, according to some embodiments.

### Example 7

### Synthesis of iPrSn(N(SiMe₃)₂)₂I

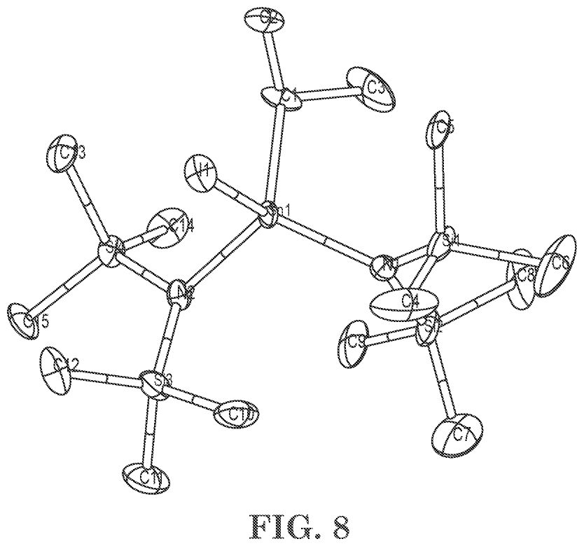

Sn(N(SiMe₃)₂)₂ (2.0 g, 4.53 mmol) was placed in a 40 mL vial equipped with a magnetic stir bar and diluted with 20 mL of hexanes. Separately, 2-iodopropane (0.807 g, 4.75 mmol) was diluted with 5 mL of hexanes and the solution added directly to the Sn-amide solution with stirring over the course of 1 minute. The resulting dark red solution was stirred for 12 hours, at which point, the reaction presented as a slightly cloudy pale-yellow solution. The reaction was filtered through a 0.2 μm syringe filter and the resulting light-yellow solution dried under reduced pressure to yield the product (iPrSn(N(SiMe₃)₂)₂I) as a pale-yellow solid. Isolated 2.40 g, Yield: 86.9%. X-ray quality crystals were grown by cooling a hexanes solution in the freezer at −35° C. ¹H-NMR (400 MHz, C₆D₆, 298K): 0.36 (s, 36H); 1.27 (d, 6H); 2.06 (sept, 1H) ppm; ¹³C{¹H}-NMR (100 MHz, C₆D₆, 298K): 6.35; 21.76; 31.40 ppm; ²⁹Si-NMR (79 MHz, C₆D₆, 298K): 5.70 ppm; ¹¹⁹Sn{¹H}-NMR (149 MHz, C₆D₆, 298K): −102.91 ppm. FIG. 8 depicts a three-dimensional solid-state structure of iPrSn(N(SiMe₃)₂)₂I, according to some embodiments.

### Example 8

### Synthesis of CF₃CH₂Sn(OtBu)₃

CF₃CH₂Sn(pip^{Me4})₂I (1.0 g, 1.64 mmol) was loaded into an amber vial equipped with a magnetic stir bar and dissolved in 5 mL of tetrahydrofuran. Separately, tert-butanol (0.382 g, 5.16 mmol) and triethylamine (0.497 g, 4.92 mmol) were diluted with 5 mL of tetrahydrofuran and added to the CF₃CH₂Sn(pip^{Me4})₂I solution with stirring over the course of two minutes. The reaction was stirred for 12 hours at room temperature, the resulting yellow mixture filtered through a 0.2 μm syringe filter to yield a yellow solution, and the volatiles removed under reduced pressure to yield a product mixture of Hpip^{Me4} and CF₃CH₂Sn(O^{t}Bu)₃ as a light-yellow liquid in 96.8% purity by ¹¹⁹Sn-NMR. Total Mass: 0.89 g, corrected Mass: 0.61 g, yield 88.4% ¹H-NMR (400 MHz, C₆D₆, 298K): 1.31 (s, 27H); 1.80 (q, 2H) ppm; ¹³C{¹H}-NMR (100 MHz, C₆D₆, 298K): 28.54 (q); 33.57; 74.40; 127.30 (q) ppm; ¹⁹F-NMR (376 MHz, C₆D₆, 298K): −51.93 (t) ppm; ¹¹⁹Sn{¹H}-NMR (149 MHz, C₆D₆, 298K): −228.35 (q) ppm.

### Example 9

### Synthesis of FCH₂Sn(O^{t}Bu)₃

In a nitrogen-filled glovebox, Sn(pip^{Me4})₂ (15.0 g, 37.3 mmol) was loaded into a 250 mL roundbottom schlenk flask equipped with a magnetic stir bar and dissolved in 250 mL of THE to form a dark red solution. ICH₂F (CAS #373-53-5, 5.96 g, 37.3 mmol) was added dropwise to the tin amide solution over the course of five minutes. The resulting dark red solution stirred at room temperature for 2 hours, at which point KOtBu (CAS #865-47-4, 4.16 g, 37.1 mmol) was added to the reaction with stirring over the course of 15 minutes, resulting in the formation of a pale-yellow precipitate. The reaction mixture was stirred for 20 minutes prior to addition of a 20 mL THE solution of ^{t}BuOH (CAS #75-65-0, 5.55 g, 74.9 g) over the course of 10 minutes, resulting in a slight exotherm. The resulting dark orange reaction mixture was stirred for 12 hours, the volatiles removed under reduced pressure, the peach-colored product matrix extracted with 250 mL of hexanes and filtered through a plug of celite suspended over a disposable polyethylene filter frit, the frit washed with 25 ml of hexanes, and the combined organic solutions dried under reduced pressure to yield a mixture of FCH₂Sn(O^{t}Bu)₃ and Hpip^{Me4} as a dark red liquid. Mass: 17.27 g. A 7.82 g aliquot of the crude mixture was loaded into a 50 mL roundbottom Schlenk flask and equipped with a shortpath distillation head with receiving flask and thermometer combination. The product was distilled under reduced pressure at a head temperature of 22-25° C. (50-60 mTorr) to yield FCH₂Sn(O^{t}Bu)₃ as a colorless liquid in 98.5% purity by ¹¹⁹Sn— and ¹⁹F-NMR. Mass: 2.43 g ¹H-NMR (400 MHz, C₆D₆, 298K): 1.34 (s, 27H); 4.69 (d, 2H) ppm; ¹³C{¹H}-NMR (100 MHz, C₆D₆, 298K): 33.78; 73.51; 84.51 (d) ppm; ¹⁹F-NMR (376 MHz, C₆D₆, 298K): −261.01 (t) ppm; ¹¹⁹Sn{¹H}-NMR (149 MHz, C₆D₆, 298K): −256.19 (d) ppm.

### Example 10

### Synthesis of O(CH₂)₂HCSn(O^{t}Bu)₃

Sn(pip^{Me4})₂ (5.0 g, 12.4 mmol) was placed in an amber vial and dissolved in THE (20 mL). 1-iodooxetane (2.39 g, 13.0 mmol) was diluted with 5 mL of THE and added to the Sn-amide solution over the course of 2 minutes. The resulting dark red solution was stirred for 1.5 hours, at which point solid KOtBu (1.38 g, 12.3 mmol) was added directly to the reaction mixture over the course of five minutes resulting in the presentation of an orange precipitate. The reaction was stirred for 1 hour, at which point a 10 mL THE solution of ^{t}BuOH (1.83 g, 24.8 mmol) was added to the mixture. The resulting dark orange/red mixture and was stirred at room temperature for 60 hours, at which point the mixture was filtered through a 0.2 μm syringe filter and dried under reduced pressure to yield a dark red viscous oil composed of a mixture of Hpip^{Me4} and O(CH₂)₂HCSn(O^{t}Bu)₃. Mass: 2.73 g. ¹H-NMR (400 MHz, C₆D₆, 298K): 1.28 (s, 27H); 2.89 (pent, 1H); 4.67 (dd, 2H); 4.95 (dd, 2H) ppm; ¹¹⁹Sn{¹H}-NMR (149 MHz, C₆D₆, 298K): −218.38 ppm.

### Example 11

### Synthesis of CH₃C≡CCH₂Sn(pip^{Me4})₂Br

Sn(pip^{Me4})₂ (1.0 g, 2.49 mmol) was placed in a 40 mL vial equipped with a magnetic stir bar and diluted with 2 mL of C₆D₆. To the solution, 1-bromo-2-butyne (0.331 g, 2.49 mmol) was added directly to the Sn-amide solution with stirring over the course of 1 minute. The resulting dark red solution was stirred for 4 hours, at which point, the reaction presented as a slightly cloudy dark-yellow solution. The reaction was filtered through a 0.2 μm syringe filter to yield dark-yellow solution of the product. ¹H-NMR (400 MHz, C₆D₆, 298K): 1.04 (s, 3H); 1.38 (t, 8H); 1.49 (s, 12H), 1.57 (s, 12H), 1.62 (m, 4H), 2.42 (s, 2H) ppm; ¹³C{¹H}-NMR (100 MHz, C₆D₆, 298K): 3.81, 17.81, 33.89, 34.47, 42.33, 58.12, 78.21, 77.25 ppm; ¹¹⁹Sn{¹H}-NMR (149 MHz, C₆D₆, 298K): −139.6 ppm.

### Example 12

### Synthesis of CH₃C≡CCH₂Sn(O^{t}Bu)₃

In a 100 mL schlenk flask in the glovebox, Sn(pip^{Me4})₂ (5 g, 12.4 mmol) was dissolved in 10 mL of THF. To this dark red solution was added 1-bromobut-2-yne (1.64 g, 12.4 mmol). Over a couple of minutes the color of the solution changed from a deep red to a deep dark orange/brown color. The solution was allowed to stir overnight at room temperature. A ¹¹⁹Sn NMR showed one clean peak at −140.4 ppm for CH₃CCCH₂Sn(pip^{Me4})₂ Br. To the solution triethyl amine (3.76 g, 37.2 mmol) was added followed by t-butanol (2.76 g, 37.2 mmol). Solids were observed to be formed. Allowed to stir overnight at room temperature. The solution was then filtered and solids washed with hexane. Volatiles were removed under reduced pressure to yield a product mixture of Hpip^{Me4} and CH₃CCCH₂Sn(O^{t}Bu)₃ as a dark-orange liquid in 78% purity by ¹¹⁹Sn-NMR. ¹H-NMR (400 MHz, C₆D₆, 298K): 1.31 (s, 3H); 1.35 (s, 27H); 1.98 (s, 2H) ppm; ¹¹⁹Sn{¹H}-NMR (149 MHz, C₆D₆, 298K): −233.8 ppm.

TABLE 1
Crystal data and structure refinement for CF₃CH₂Sn(N(SiMe₃)₂)₂I.

| Empirical formula | C14 H38 F3 I N2 Si4 Sn | |
|---|---|---|
| Molecular formula | C14 H38 F3 I N2 Si4 Sn | |
| Formula weight | 649.41 | |
| Temperature | 100.0 K | |
| Wavelength | 0.71073 Å | |
| Crystal system | Monoclinic | |
| Space group | C 1 2/c 1 | |
| Unit cell dimensions | a = 17.4520(7) Å | a = 90°. |
| | b = 8.8141(4) Å | b = 113.8730(10)°. |
| | c = 18.8726(11) Å | g = 90°. |

| | |
|---|---|
| Volume | 2654.7(2) Å³ |
| Z | 4 |
| Density (calculated) | 1.625 Mg/m³ |
| Absorption coefficient | 2.329 mm⁻¹ |
| F(000) | 1288 |
| Crystal size | 0.08 × 0.06 × 0.05 mm³ |
| Crystal color, habit | colorless block |
| Theta range for data collection | 2.360 to 26.733°. |
| Index ranges | −22 <= h <= 22, −11 <= k <= 11, −23 <= I <= 23 |
| Reflections collected | 45843 |
| Independent reflections | 2831 [R(int) = 0.0532] |
| Completeness to theta = 25.242° | 100.0% |
| Absorption correction | Semi-empirical from equivalents |
| Max. and min. transmission | 0.4912 and 0.4110 |
| Refinement method | Full-matrix least-squares on F² |
| Data/restraints/parameters | 2831/0/147 |
| Goodness-of-fit on F² | 1.062 |
| Final R indices [I > 2sigma(I)] | R1 = 0.0184, wR2 = 0.0388 |
| R indices (all data) | R1 = 0.0207, wR2 = 0.0394 |
| Largest diff. peak and hole | 0.332 and −0.303 e · Å⁻³ |

TABLE 2
Crystal data and structure refinement for iPrSn(N(SiMe₃)₂)₂I.

| Empirical formula | C15 H43 I N2 Si4 Sn | |
|---|---|---|
| Molecular formula | C15 H43 I N2 Si4 Sn | |
| Formula weight | 609.46 | |
| Temperature | 100.15 K | |
| Wavelength | 0.71073 Å | |
| Crystal system | Orthorhombic | |
| Space group | Iba2 | |
| Unit cell dimensions | a = 36.219(2) Å | a = 90°. |
| | b = 17.6925(11) Å | b = 90°. |
| | c = 8.9108(5) Å | g = 90°. |

| | |
|---|---|
| Volume | 5710.1(6) Å³ |
| Z | 8 |
| Density (calculated) | 1.418 Mg/m³ |
| Absorption coefficient | 2.146 mm⁻¹ |
| F(000) | 2448 |
| Crystal size | 0.2 × 0.085 × 0.025 mm³ |
| Crystal color, habit | colorless plank |
| Theta range for data collection | 1.281 to 26.370°. |
| Index ranges | −45 <= h <= 32, −21 <= k <= 22, −11 <= I <= 11 |
| Reflections collected | 29285 |
| Independent reflections | 5827 [R(int) = 0.0243] |
| Completeness to theta = 25.242° | 100.0% |
| Absorption correction | Semi-empirical from equivalents |
| Max. and min. transmission | 0.0937 and 0.0627 |
| Refinement method | Full-matrix least-squares on F² |
| Data/restraints/parameters | 5827/19/222 |
| Goodness-of-fit on F² | 1.330 |
| Final R indices [I > 2sigma(I)] | R1 = 0.0440, wR2 = 0.1105 |
| R indices (all data) | R1 = 0.0444, wR2 = 0.1107 |
| Absolute structure parameter | 0.062(7) |
| Largest diff. peak and hole | 1.266 and −2.043 e · Å⁻³ |

TABLE 3
Crystal data and structure refinement for Sn(pip^{Me4})₂.

| Empirical formula | C18 H36 N2 Sn | | |
|---|---|---|---|
| Molecular formula | C18 H36 N2 Sn | | |
| Formula weight | 399.18 | | |
| Temperature | 100.00 | K | |
| Wavelength | 0.71073 | Å | |
| Crystal system | Monoclinic | | |
| Space group | P 1 21/n 1 | | |
| Unit cell dimensions | a = 12.4274(5) Å | a = | 90°. |
| | b = 12.5458(5) Å | b = | 107.3590(10)°. |
| | c = 12.9252(5) Å | g = | 90°. |

| Volume | 1923.41(13) | Å³ |
|---|---|---|
| Z | 4 | |
| Density (calculated) | 1.378 | Mg/m³ |
| Absorption coefficient | 1.327 | mm⁻¹ |
| F(000) | 832 | |
| Crystal size | 0.22 × 0.2 × 0.16 mm³ | |
| Crystal color, habit | red block | |
| Theta range for data collection | 2.573 to 27.535°. | |
| Index ranges | −16 <= h <= 16, −16 <= k <= 16, | |
| | −16 <= l <= 16 | |
| Reflections collected | 57925 | |
| Independent reflections | 4433 | [R(int) = 0.0308] |

| | |
|---|---|
| Completeness to theta = 25.242° | 99.9% |
| Absorption correction | Semi-empirical from equivalents |
| Max. and min. transmission | 0.5629 and 0.5238 |
| Refinement method | Full-matrix least-squares on F² |
| Data/restraints/parameters | 4433/0/198 |
| Goodness-of-fit on F² | 1.049 |
| Final R indices [I > 2sigma(I)] | R1 = 0.0147, wR2 = 0.0351 |
| R indices (all data) | R1 = 0.0163, wR2 = 0.0358 |
| Largest diff. peak and hole | 0.412 and −0.490 e · Å⁻³ |

### Aspects

Various Aspects are described below. It is to be understood that any one or more of the features recited in the following Aspect(s) can be combined with any one or more other Aspect(s).
Aspect 1. A method comprising:
   contacting a stannic compound with a reactant to form a mono-substituted tin compound via ligand exchange,
      wherein the stannic compound is a compound of the formula:

RSn(L)ₙX,
where:
   R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, an ether, an amine, a halide, an imide, a cyanate, a nitrile, an alkoxide, or any combination thereof;
   L is a bulky monoanionic ligand or a bulky dianionic ligand;
   n is 1 or 2, provided that n is 1 when L is a bulky dianionic ligand and n is 2 when L is a bulky monoanionic ligand; and
   X is a halide.
Aspect 2. The method according to Aspect 1, wherein R comprises at least one of —CH₂CF₃, —CH(CF₃)₂, —CH₂F, —CH₂CH₂F, —CF₃, —CF₂CF₃, or any combination thereof.
Aspect 3. The method according to any one of Aspects 1-2, wherein R comprises at least one of —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —CHS, —CH₂ (C₆H₅), —CH═CH₂, —C≡CCH₃, —CH₂C≡CH, —CH₂C≡CCH₃, —C(CH₃)═CH₂, —HC≡CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.
Aspect 4. The method according to any one of Aspects 1-3, wherein L is:

—NR^{a}R^{b},
where:
   R^{a} and R^{b} are independently a hydrogen, an alkyl, or a silyl, or R^{a} and R^{b} are bonded to each other to form a C₃-C₂₀ N-heterocycle.
Aspect 5. The method according to any one of Aspects 1-4, wherein L is:

—OR^{c},
where:
   R^{c} is an alkyl, a silylalkyl, a cycloalkyl, or an aryl.
Aspect 6. The method according to any one of Aspects 1-5, wherein at least one L is 2,2,6,6-tetramethylpiperidide.
Aspect 7. The method according to any one of Aspects 1-6, wherein at least one L is N,N′-di-tert-butylethylenediamide.
Aspect 8. The method according to any one of Aspects 1-7, wherein at least one L is —N(Si(CH₃)₃)₂.
Aspect 9. The method according to any one of Aspects 1-8, wherein the stannic compound is an alkylated mixed ligand tin (IV) compound.
Aspect 10. The method according to any one of Aspects 1-9, wherein the reactant comprises at least one compound of the formula:

HL¹ or Mq¹L_{z}¹,
where:
   L¹ is a monoanionic ligand or a dianionic ligand;
   M¹ is a metal cation;
   X¹ is a halide;
   q is 1 or 2; and
   z is 1, 2, 3, or 4.
Aspect 11. The method according to Aspect 10, wherein L¹ is —OR^{d}, —NR^{d}R^{e}, —NCO, —OC(═O)NR^{d}R^{e}, —NR^{d}C(═O)OR^{e}, —OC(═O)CH₃, —NR^{d}(CH₂)ₙNR^{d}R^{e}, —NR^{d}(CH₂)ₙR^{e}N—, —O(CH₂)ₙO—, —O(CH₂)ₙOR^{d}, —O(CH₂)ₙNR^{d}R^{e}, —O(CH₂)ₙR^{d}N—, or —C≡CR^{d},
   where:
      R^{d} and R^{e} are each independently a hydrogen, an alkyl, an alkenyl, an alkynyl, a cycloalkyl, an aryl, a silyl, a silylalkyl, an aminoalkyl, an alkoxyalkyl, or an aralkyl; and
      n is 1 to 30.
Aspect 12. The method according to any one of Aspects 10-11, wherein at least one of R^{d} or R^{e} is trimethylsilyl.
Aspect 13. The method according to any one of Aspects 10-12, wherein L¹ is —N(CH₃)₂, —OC(CH₃)₃, —C≡CC(CH₃)₃, —C≡CCH₃, or —OSi(CH₃)₃.
Aspect 14. The method according to any one of Aspects 10-13, wherein M¹ is an alkali metal cation, an alkaline earth metal cation, a transition metal cation, or a post-transition metal cation.
Aspect 15. The method according to any one of Aspects 10-14, wherein M¹ is Sn(II).
Aspect 16. The method according to any one of Aspects 10-15, wherein M¹ is Sn(IV).
Aspect 17. The method according to any one of Aspects 10-16, wherein M¹ is Li⁺, Na⁺, K⁺, R^{b+}, Cs⁺, Mg²⁺, Ca²⁺, Sr²⁺, Ba²⁺, or Zn²⁺.
Aspect 18. The method according to any one of Aspects 1-17, wherein the reactant comprises at least one of HC≡CCH₃, HOC(CH₃)₃, HC≡CC(CH₃)₃, HOSi(CH₃)₃, or any combination thereof.
Aspect 19. The method according to Aspect 18, wherein the reactant further comprises at least one of HNEt₂, NEt₃, 2,2,6,6-tetramethylpiperidine, or any combination thereof.
Aspect 20. The method according to any one of Aspects 18-19, wherein the reactant comprises at least one of Sn(N(CH₃)₂)₂, Sn(N(CH₃)₂)₄, Sn(OC(CH₃)₃)₂, Sn(OC(CH₃)₃)₄, SnCl₂, SnCl₄, SnI₂, SnI₄, SnBr₂, SnBr₄, or any combination thereof.
Aspect 21. The method according to any one of Aspects 18-20, wherein the reactant further comprises at least one of LiN(CH₃)₂, Na(OC(CH₃)₃), K(OC(CH₃)₃), HOC(CH₃)₃, NaOSi(CH₃)₃, LiOSi(CH₃)₃, CH₃C≡CMgBr, NaCl, KCl, or any combination thereof.
Aspect 22. The method according to any one of Aspects 1-21, wherein the mono-substituted tin compound is a compound of the formula:

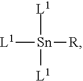

where:
   R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
   L¹ is independently a monoanionic ligand or a dianionic ligand, or a halide.
Aspect 23. The method according to any one of Aspects 1-22, further comprising:
   contacting a stannous halide with a metalated reactant to form a stannylene compound; and
   contacting the stannylene compound with a halide compound to form the stannic compound.
Aspect 24. The method according to Aspect 23, wherein the stannous halide comprises at least one of SnCl₂, SnBr₂, or SnI₂.
Aspect 25. The method according to any one of Aspects 23-24, wherein the metalated reactant comprises a compound of the formula:

ML,
where:
   M is an alkali metal cation, an alkaline earth metal cation, a transition metal cation, or a post-transition metal cation; and
   L is a bulky monoanionic ligand or a bulky dianionic ligand.
Aspect 26. The method according to Aspect 25, wherein M is Li⁺, Na⁺, K⁺, R^{b+}, Cs⁺, Mg²⁺, Ca²⁺, Sr²⁺, Ba²⁺, or Zn²⁺.
Aspect 27. The method according to any one of Aspects 25-26, wherein the metalated reactant comprises lithium tetramethylpiperidide.
Aspect 28. The method according to any one of Aspects 23-27, wherein the stannylene compound comprises a compound of the formula:

SnLₙ,
where:
   L is a monoanionic ligand or a dianionic ligand; and
   n is 1 or 2, provided that n is 1 when L is a dianionic ligand and n is 2 when L is a monoanionic ligand.
Aspect 29. The method according to any one of Aspects 23-28, wherein the stannylene compound comprises tin (II) (2,2,6,6-tetramethylpiperidide)₂.
Aspect 30. The method according to any one of Aspects 23-29, wherein the halide compound comprises a compound of the formula:

RX,
where:
   R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
   X is a halide.
Aspect 31. A composition comprising:
   a stannylene compound of the formula:

SnLₙ,
where:
   L is a bulky monoanionic ligand or a bulky dianionic ligand; and
   n is 1 or 2, provided that n is 1 when L is a bulky dianionic ligand and n is 2 when L is a bulky monoanionic ligand.
Aspect 32. The composition according to Aspect 31, wherein the stannylene compound is a compound of the formula:

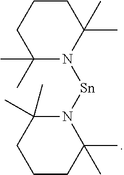

Aspect 33. A composition comprising:
   a stannic compound of the formula:

RSn(L)ₙX,
where:
   R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof;
   L is a bulky monoanionic ligand or a bulky dianionic ligand;
   n is 1 or 2, provided that n is 1 when L is a bulky dianionic ligand and n is 2 when L is a bulky monoanionic ligand; and
   X is a halide.
Aspect 34. The composition according to Aspect 33, wherein R comprises at least one of —CH₂CF₃, —CH(CF₃)₂, —CH₂F, —CH₂CH₂F, —CF₃, —CF₂CF₃, or any combination thereof.
Aspect 35. The composition according to any one of Aspects 33-34, wherein R comprises at least one of —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —CHS, —CH₂ (C₆H₅), —CH═CH₂, —C≡CCH₃, —CH₂C≡CH, —CH₂C≡CCH₃, —C(CH₃)═CH₂—HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.
Aspect 36. The composition according to any one of Aspects 33-35, wherein L is:

—NR^{a}R^{b},
where:
   R^{a} and R^{b} are independently a hydrogen, an alkyl, or a silyl, or R^{a} and R^{b} are bonded to each other to form a C₃-C₂₀ N-heterocycle.
Aspect 37. The composition according to any one of Aspects 33-36, wherein L is:

—OR^{c},
where:
   R^{c} is an alkyl, a cycloalkyl, or an aryl.
Aspect 38. The composition according to any one of Aspects 33-37, wherein at least one L is 2,2,6,6-tetramethylpiperidide.
Aspect 39. The composition according to any one of Aspects 33-38, wherein at least one L is N,N′-di-tert-butylethylenediamide.
Aspect 40. The composition according to any one of Aspects 33-39, wherein at least one L is —N(Si(CH₃)₃)₂.
Aspect 41. The composition according to any one of Aspects 33-40, wherein the stannic compound is:

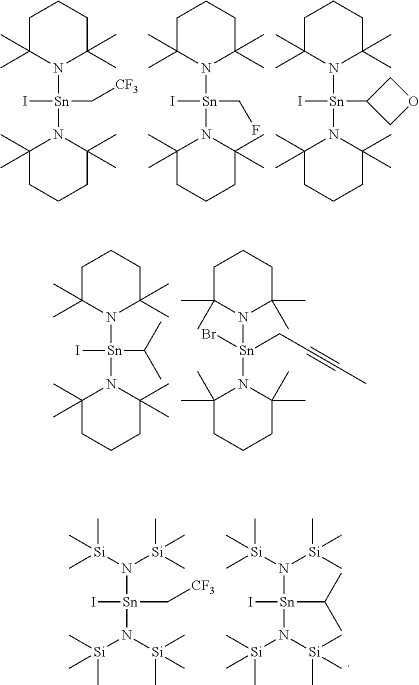

Aspect 42. A composition comprising:
   a mono-substituted tin compound of the formula:

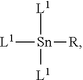

where:
   R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
   L¹ is independently a monoanionic ligand or a dianionic ligand, or a halide.
Aspect 43. The composition according to Aspect 42, wherein the mono-substituted tin compound comprises at least two different ligands (L¹).
Aspect 44. The composition according to any one of Aspects 42-43, wherein each L¹ is different.
Aspect 45. The composition according to any one of Aspects 42-44, wherein each L¹ is the same.
Aspect 46. The composition according to any one of Aspects 42-45, wherein L¹ is —OR^{d}, —NR^{d}R^{e}, —NCO, —OC(═O)NR^{d}R^{e}, —NR^{d}C(═O)OR^{e}, —OC(═O)CH₃, —NR^{d}(CH₂)ₙNR^{d}R^{e}, —NR^{d}(CH₂)ₙR^{e}N—, —O(CH₂)ₙO—, —O(CH₂)ₙOR^{d}, —O(CH₂)ₙNR^{d}R^{e}, —O(CH₂)ₙR^{d}N—, or —C≡CR^{d},
   where:
      R^{d} and R^{e} are each independently a hydrogen, an alkyl, an alkenyl, an alkynyl, a cycloalkyl, an aryl, a silyl, a silylalkyl, an aminoalkyl, an alkoxyalkyl, or an aralkyl; and
      n is 1 to 30.
Aspect 47. The composition according to any one of Aspects 42-46, wherein L¹ is —N(CH₃)₂.
Aspect 48. The composition according to any one of Aspects 42-47, wherein L¹ is —OC(CH₃)₃.
Aspect 49. The composition according to any one of Aspects 42-48, wherein L¹ is independently:

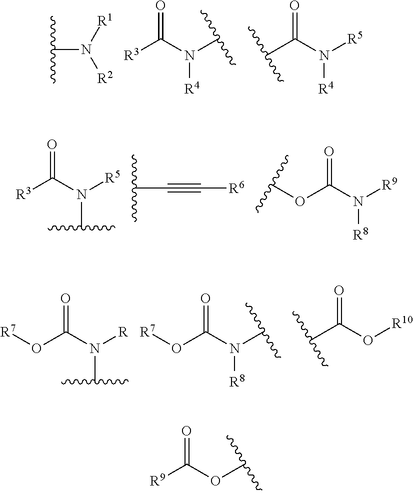

where:
   R¹, R², R³, R⁴, R⁵, R⁶, R⁷, R⁸, R⁹, and R¹⁰ are independently an alkyl, an alkenyl, an alkynyl, a cycloalkyl, an aryl, a silyl, a silylalkyl, an aminoalkyl, an alkoxyalkyl, or an aralkyl.
Aspect 50. The composition according to any one of Aspects 42-49, wherein L¹ is independently:

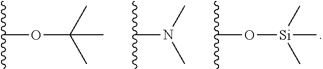

Aspect 51. The composition according to any one of Aspects 42-50, wherein the compound is at least one of the following:

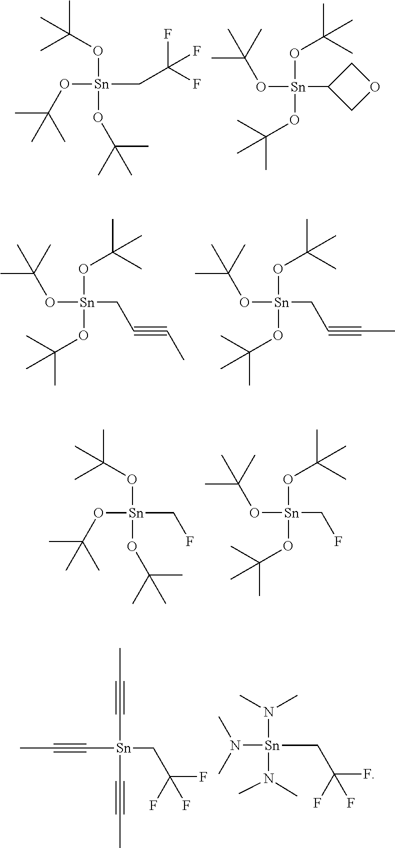

Aspect 52. The composition according to any one of Aspects 42-51, wherein the composition comprises less than 5% by weight of a disubstituted tin (IV) compound based on a total weight of the composition.
Aspect 53. The composition according to Aspect 52, wherein the disubstituted tin (IV) compound is a compound of the formula:

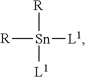

where:
   R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, an ether, an amine, an imide, a cyanate, a nitrile, an alkoxide, or any combination thereof; and
   L¹ is independently a monoanionic ligand or a dianionic ligand.
Aspect 54. The composition according to any one of Aspects 42-53, wherein the composition comprises at least 99.5% by weight of the mono-substituted tin compound based on a total weight of the composition.
Aspect 55. The composition according to any one of Aspects 42-54, wherein the composition comprises at least 99.9% by weight of the mono-substituted tin compound based on a total weight of the composition.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
contacting a stannic compound with a reactant to form a mono-substituted tin compound via ligand exchange,
wherein the stannic compound is a compound of the formula:
RSn(L)ₙX,
where:
R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, an ether, an amine, a halide, an imide, a cyanate, a nitrile, an alkoxide, or any combination thereof;
L is a bulky monoanionic ligand or a bulky dianionic ligand;
n is 1 or 2, provided that n is 1 when L is a bulky dianionic ligand and n is 2 when L is a bulky monoanionic ligand; and
X is a halide.

2. The method of claim 1, wherein R comprises at least one of —CH₂CF₃, —CH(CF₃)₂, —CH₂F, —CH₂CH₂F, —CF₃, —CF₂CF₃, or any combination thereof.

3. The method of claim 1, wherein R comprises at least one of —CH₃, —CH₂CH₃, —CH₂CH₂CH₃, —CH(CH₃)₂, —CH(CH₃)CH₂CH₃, —CH₂CH(CH₃)₂, —C(CH₃)₃, —(CH₂)₃CH₃, —C₆H₅, —CH₂(C₆H₅), —CH═CH₂, —C≡CCH₃, —CH₂C≡CH, —CH₂C≡CCH₃, —C(CH₃)═CH₂, —HC═CHCH₃, —CH₂CH═CH₂, —CH₂N(CH₃)₂, —(CH₂)₃N(CH₃)₂, —CH₂CH₂OCH₃, —CH(CH₂)₂₀, —CH₂Si(CH₃)₃, —Si(CH₃)₃, or any combination thereof.

4. The method of claim 1, wherein L is:
—NR^{a}R^{b},
where:
R^{a} and R^{b} are independently a hydrogen, an alkyl, or a silyl, or R^{a} and R^{b} are bonded to each other to form a C₃-C₂₀ N-heterocycle.

5. The method of claim 1, wherein L is:
—OR^{c},
where:
R^{c} is an alkyl, a silylalkyl, a cycloalkyl, or an aryl.

6. The method of claim 1, wherein at least one L is 2,2,6,6-tetramethylpiperidide.

7. The method of claim 1, wherein at least one L is N,N′-di-tert-butylethylenediamide.

8. The method of claim 1, wherein at least one L is —N(Si(CH₃)₃)₂.

9. The method of claim 1, wherein the stannic compound is an alkylated mixed ligand tin (IV) compound.

10. The method of claim 1, wherein the reactant comprises at least one compound of the formula:
HL¹ or Mq¹L_{z}¹,
where:
L¹ is a monoanionic ligand or a dianionic ligand;
M¹ is a metal cation;
X¹ is a halide;
q is 1 or 2; and
z is 1, 2, 3, or 4.

11. The method of claim 10, wherein L¹ is —OR^{d}, —NR^{d}R^{e}, —NCO, —OC(═O)NR^{d}R^{e}, —NR^{d}C(═O)OR^{e}, —OC(═O)CH₃, —NR^{d}(CH₂)ₙNR^{d}R^{e}, —NR^{d}(CH₂)ₙR^{e}N—, —O(CH₂)ₙO—, —O(CH₂)ₙOR^{d}, —O(CH₂)ₙNR^{d}R^{e}, —O(CH₂)ₙR^{d}N—, or —C≡CR^{d},
where:
R^{d} and R^{e} are each independently a hydrogen, an alkyl, an alkenyl, an alkynyl, a cycloalkyl, an aryl, a silyl, a silylalkyl, an aminoalkyl, an alkoxyalkyl, or an aralkyl; and
n is 1 to 30.

12. The method of claim 11, wherein at least one of R^{d} or R^{e} is trimethylsilyl.

13. The method of claim 10, wherein L¹ is —N(CH₃)₂, —OC(CH₃)₃, —C≡CC(CH₃)₃, —C≡CCH₃, or —OSi(CH₃)₃.

14. The method of claim 10, wherein M¹ is an alkali metal cation, an alkaline earth metal cation, a transition metal cation, or a post-transition metal cation.

15. The method of claim 10, wherein M¹ is Sn(II).

16. The method of claim 10, wherein M¹ is Sn(IV).

17. The method of claim 10, wherein M¹ is Li⁺, Na⁺, K⁺, R^{b+}, Cs⁺, Mg²⁺, Ca²⁺, Sr²⁺, Ba²⁺, or Zn²⁺.

18. The method of claim 1, wherein the reactant comprises at least one of HC≡CCH₃, HOC(CH₃)₃, HC≡CC(CH₃)₃, HOSi(CH₃)₃, or any combination thereof.

19. The method of claim 18, wherein the reactant further comprises at least one of HNEt₂, NEt₃, 2,2,6,6-tetramethylpiperidine, or any combination thereof.

20. The method of claim 1, wherein the reactant comprises at least one of Sn(N(CH₃)₂)₂, Sn(N(CH₃)₂)₄, Sn(OC(CH₃)₃)₂, Sn(OC(CH₃)₃)₄, SnCl₂, SnCl₄, SnI₂, SnI₄, SnBr₂, SnBr₄, or any combination thereof.

21. The method of claim 18, wherein the reactant further comprises at least one of LiN(CH₃)₂, Na(OC(CH₃)₃), K(OC(CH₃)₃), HOC(CH₃)₃, NaOSi(CH₃)₃, LiOSi(CH₃)₃, CH₃C≡CMgBr, NaCl, KCl, or any combination thereof.

22. The method of claim 1, wherein the mono-substituted tin compound is a compound of the formula: 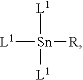
where:
R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
L¹ is independently a monoanionic ligand or a dianionic ligand, or a halide.

23. The method of claim 1, further comprising:
contacting a stannous halide with a metalated reactant to form a stannylene compound; and
contacting the stannylene compound with a halide compound to form the stannic compound.

24. The method of claim 23, wherein the stannous halide comprises at least one of SnCl₂, SnBr₂, or SnI₂.

25. The method of claim 23, wherein the metalated reactant comprises a compound of the formula:
ML,
where:
M is an alkali metal cation, an alkaline earth metal cation, a transition metal cation, or a post-transition metal cation; and
L is a bulky monoanionic ligand or a bulky dianionic ligand.

26. The method of claim 25, wherein M is Li⁺, Na⁺, K⁺, R^{b+}, Cs⁺, Mg²⁺, Ca²⁺, Sr²⁺, Ba²⁺, or Zn²⁺.

27. The method of claim 23, wherein the metalated reactant comprises lithium tetramethylpiperidide.

28. The method of claim 23, wherein the stannylene compound comprises a compound of the formula:
SnLₙ,
where:
L is a monoanionic ligand or a dianionic ligand; and
n is 1 or 2, provided that n is 1 when L is a dianionic ligand and n is 2 when L is a monoanionic ligand.

29. The method of claim 23, wherein the stannylene compound comprises tin (II) (2,2,6,6-tetramethylpiperidide)₂.

30. The method of claim 23, wherein the halide compound comprises a compound of the formula:
RX,
where:
R comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, or any combination thereof; and
X is a halide.
